(19) United States
(12) Patent Application Publication
(10) Pub. No.: US 2020/0211407 A1
(43) Pub. Date: Jul. 2, 2020

(54) CONTENT REFINEMENT EVALUATION TRIGGERING

(71) Applicant: Pearson Education, Inc., Bloomington, MN (US)

(72) Inventor: Leslie Salazar BUSHELL, Lakewood, CO (US)

(21) Appl. No.: 16/813,186

(22) Filed: Mar. 9, 2020

Related U.S. Application Data
(63) Continuation-in-part of application No. 15/172,065, filed on Jun. 2, 2016.
(60) Provisional application No. 62/170,570, filed on Jun. 3, 2015.

(51) Int. Cl. G09B 7/00; G06Q 50/20; G06Q 30/02

(52) U.S. Cl. CPC G09B 7/00; G06Q 30/0203; G06Q 50/205

(57) ABSTRACT

A content delivery system is disclosed herein. The content delivery system includes a content management server, a survey server, and a database server that are communicatingly connected with a plurality of user devices. The database server includes a plurality of databases that are organized in a tiered memory such that prioritized data is placed in memory tier having faster components and non-prioritized data is placed in a memory tier having relatively slower components. The content distribution system can determine when to generate an evaluation and provide an evaluation based on course data and one or several triggers.

### CROSS-REFERENCES TO RELATED APPLICATIONS

This application is a continuation-in-part of U.S. patent application Ser. No. 15/172,065, filed on Jun. 2, 2016, and entitled “CONTENT REFINEMENT EVALUATION TRIGGERING SYSTEM,” which claims the benefit of U.S. Provisional Application No. 62/170,570, filed on Jun. 3, 2015, and entitled “CONTENT REFINEMENT EVALUATION TRIGGERING SYSTEM,” the entirety of which is hereby incorporated by reference herein

### BACKGROUND

A computer network or data network is a telecommunications network which allows computers to exchange data. In computer networks, networked computing devices exchange data with each other using a data link. The connections between nodes are established using either cable media or wireless media. The best-known computer network is the Internet.

Network computer devices that originate, route and terminate the data are called network nodes. Nodes can include hosts such as personal computers, phones, servers as well as networking hardware. Two such devices can be said to be networked together when one device is able to exchange information with the other device, whether or not they have a direct connection to each other.

Computer networks differ in the transmission medium used to carry their signals, the communications protocols to organize network traffic, the network's size, topology and organizational intent. While computer networks provide many benefits and advantages, further developments to computer networks are desired to improve the functionality and usefulness of computer networks.

### BRIEF SUMMARY OF THE INVENTION

One aspect of the present disclosure relates to a system for automatic content refinement evaluation triggering. The system includes memory including: a survey database including data identifying a plurality of triggers delineating between indications of circumstances in which a survey should be provided, and circumstances in which a survey should not be provided. The system can include a plurality of user devices. In some embodiments, each of the plurality of user devices includes: a first network interface that can exchange data via the communication network; and a first Input/Output (I/O) subsystem that can convert electrical signals to user interpretable outputs via a user interface. The system can include a server. The server can be controlled according to computer code to: receive an indication of the initiation of a course, which course includes a plurality of data packets for delivery to the plurality of user devices; receive course data, which course data identifies one of: an attendance level; a participation level, and an assignment performance level; retrieve data identifying some of the plurality of triggers from the survey database, which triggers define a threshold value; compare the course data to retrieved data identifying some of the plurality of triggers; automatically generate a survey message including a survey when comparison of the course data to the some of the plurality of triggers indicates for providing a survey; and automatically send the survey message to a recipient device, which recipient device includes at least one of the plurality of user devices, which survey message activates a user interface of the recipient device to provide the survey to the user of the recipient device.

In some embodiments, the activation of the user interface of the recipient device includes the providing of an indicator of the received survey message. In some embodiments, the indicator of the received message includes at least one of: an aural indicator, a tactile indicator, or a visual indicator.

In some embodiments, automatically generating the survey message includes generating a survey. In some embodiments, generating the survey includes retrieving a survey from the survey database. In some embodiments, the survey database includes a plurality of questions linked with the plurality of triggers.

In some embodiments, generating the survey includes: selecting some of the plurality of questions for inclusion in the survey; and compiling the questions into a survey. In some embodiments, selecting some of the plurality of questions for inclusion in the survey includes: determining the triggers indicating for providing a survey; and determining the questions associated with the determined triggers.

In some embodiments, the server can receive electronic communications from the recipient devices, which electronic communications include survey responses. In some embodiments, the server can automatically generate and send an action report.

One aspect of the present disclosure relates to a method for automatic content refinement evaluation triggering. The method includes receiving an indication of the initiation of a course at a server from a plurality of user devices, such as completion of a first class or learning objective within a course, which course includes a plurality of data packets for delivery to the plurality of user devices, and wherein each of the plurality of user devices includes: a first network interface that can exchange data via the communication network; and a first I/O subsystem that can convert electrical signals to user interpretable outputs via a user interface. The method includes: receiving course data at the server from the plurality of user devices, which course data identifies one of: an attendance level; a participation level, and an assignment performance level; retrieving data identifying some of the plurality of triggers from a survey database, which triggers define a threshold value; comparing the course data to retrieved data identifying some of the plurality of triggers; automatically generating a survey message including a survey when comparison of the course data to the some of the plurality of triggers indicates for providing a survey; and automatically sending the survey message to a recipient device, which recipient device includes at least one of the plurality of user devices, which survey message activates a user interface of the recipient device to provide the survey to the user of the recipient device.

In some embodiments, the activation of the user interface of the recipient device includes the providing of an indicator of the received survey message. In some embodiments, the indicator of the received message includes at least one of: an aural indicator, a tactile indicator, or a visual indicator.

In some embodiments, automatically generating the survey message includes generating a survey. In some embodiments, generating the survey includes retrieving a survey from the survey database. In some embodiments, the survey database includes a plurality of questions linked with the plurality of triggers. In some embodiments, generating the survey includes: selecting some of the plurality of questions for inclusion in the survey; and compiling the questions into a survey.

In some embodiments, the selecting some of the plurality of questions for inclusion in the survey includes: determining the triggers indicating for providing a survey; and determining the questions associated with the determined triggers. In some embodiments, the method includes receiving electronic communications from the recipient devices, which electronic communications include survey responses. In some embodiments, the method includes: automatically generating an action report; and automatically sending an action report.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure

### BRIEF DESCRIPTION OF THE DRAWINGS

The present disclosure is described in conjunction with the appended figures:

FIG. 1 is a block diagram showing illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4A is a block diagram illustrating an embodiment of one or more content management servers within a content distribution network.

FIG. 4B is a flowchart illustrating one embodiment of a process for data management.

FIG. 4C is a flowchart illustrating one embodiment of a process for evaluating a response.

FIG. 5 is a block diagram illustrating the physical and logical components of a special-purpose computer device within a content distribution network.

FIG. 6 is a block diagram illustrating one embodiment of the communication network.

FIG. 7 is a block diagram illustrating one embodiment of user device and supervisor device communication.

FIG. 8 is a block diagram illustrating an embodiment of the connection of networked devices include a user device and a supervisor device.

FIG. 9 is a schematic illustration of one embodiment of a user device for use with the content distribution network.

FIG. 10 is a flowchart illustrating one embodiment of a process for generating a trigger database.

FIG. 11 is a flowchart illustrating one embodiment of a first portion of a process for triggering an evaluation.

FIG. 12 is a flowchart illustrating one embodiment of a second portion of the process for triggering an evaluation.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Generally speaking, instructors of learning courses want successful courses, and therefore look for ways to improve their courses, whether that be through improving their own lecturing, finding optimal course resources, or helping students with the course. Instructors generally don't mind if someone has had a bad experience or that there's some bad feedback, as long as its actionable, Thus, if they are aware of a problem with a course, instructors generally want to resolve that issue, and therefore often desire to get feedback from the students enrolled in their courses.

As a result, it is not unusual for instructors to provide such students with surveys made up of multiple survey questions about the course, the course materials, the teacher's teaching or lecturing style, complications the student may have had with the course, etc. Traditionally, such surveys were provided in paper form. For example, in a typical class, a teaching assistant may hand out the evaluation, and everyone enrolled in the course completes the survey. The evaluations are then collected and recorded, possibly using scanning technology, and the instructor receives the results from the evaluation.

However, as learning programs continue to add additional staff and resources (e.g., adjunct instructors, online courses, etc.) the traditional model for distributing and analyzing surveys becomes more and more costly and time consuming. In response, some programs have transitioned from paper-based survey/evaluation tools to online-based tools. However, the only participants in the online surveys often only include those that are truly satisfied (e.g., they believe that the course was great because they received a high grade in the course), or those that did not perform well in the class, failed the class, or are otherwise truly unsatisfied with the course or the instructor. Thus, a once useful tool became much less useful, because of the lack of participation by students.

The traditional model of a single, end of term survey creates additional problems as well. For example, a single, end-of-course evaluation provides only a single data point provides only one source of data for instructors. These types of surveys also tend to only include general questions, such as “what was your opinion of the course,” or “did the course go well for you?” which may not be helpful to identify specific issues that need to be improved in the course, or with the instructor.

These types of surveys are also not personalized to the students of the course, or their unique situations. For example, a student may have a learning disability or may be dealing with a personal issue, such as a death in the family or a job loss. In situations such as these, the lack of questions or response from the class may indicate to the instructor that the material is understood, when the students actually didn't understand, but may have had other reasons for not responding. As a result, the student may give a negative review of the instructor or the course for reasons other than the course, the instructor or the course materials.

A single, end-of-term survey is therefore problematic, because with only this single generalized data point, the instructor may continue to teach for multiple semesters before they identify and can remedy the problem. For example, instructors often don't know if there's a problem with how they explained the course, the content, the material the student is using, or if the student is having an issue understanding the content or personal problems that have affected their performance in the course. Therefore, the single survey, provided at the end of the semester does not benefit the semester for which it was given, and only benefits future semesters and sections of the course.

Additionally, these evaluations often take place after final grades are posted, creating a problem similar to that described in association with online surveys above. For example, if a student does poorly in the class, they are likely to provide a negative evaluation, and if they did well, they are likely to give positive feedback. The students are unlikely, at the end of the course, to provide detail about why they are satisfied or unsatisfied with the course.

Thus, several improvements are needed for course and/or instructor surveys or evaluations. For example, various systems and methods are needed which provide surveys that allow instructors to: 1) collect survey data during the course, as a “growing evaluation,” rather than only collecting surveys at the end of the course, thereby providing instructors with valuable data to update the course, the materials within the course, and/or the instructor's own teaching style; 2) eliminate bias from a received grade at the end of a course; 3) identify key learning points and learning objectives that allow the instructor to determine a general comprehension level for the entire course; 4) provide the instructor with actions items to improve the course, or the course materials; and 5) allow the instructor to provide for students with unique needs, such as learning disabilities and personal issues.

The disclosed embodiments provide systems and methods to overcome the limitations and provide the improvements described above. Specifically, the disclosed embodiments give instructors a tool to improve upon the course, which allows the instructors to get the data back faster, and are able to adjust the course as it is happening. This may allow the instructor to improve the course over the course of two to three semesters as opposed to five or six.

To accomplish this, the disclosed systems and methods may include one or more software modules comprising instructions within memory executed by one or more servers coupled to an electronic network, and comprising one or more processors executing the instructions.

The system may further include a database and/or data store communicatively coupled to the one or more servers, which may store, as non-limiting examples: user data for system administrators, instructors, students, etc.; course data, possibly including a course plan, syllabus, learning materials, learning objectives, assignments, quizzes, tests, etc.; performance data indicating students' performance related to class participation, attendance, completion of learning objectives, assignments, quizzes, tests, etc.; one or more survey questions to be provided to students to get a more detailed understanding of their evaluation of the course or the instructor; a subject matter associated with the survey questions (e.g., learning objectives, instructor teaching style, etc.); one or more rules or additional logic for action items associated in the database with the survey questions or reporting data, possibly including pre-defined thresholds or triggers, defining when the survey questions should be combined into a survey and transmitted to the target users (e.g., students of a course, and their associated client machines), or when associated evaluation or performance reports are to be transmitted to the students, students' parents, teachers, administrators, etc.

In some embodiments, one or more of the software modules may include a plurality of pre-defined survey questions and their associated logic or rules. On installation of the software, the database may be populated with these “out of the box” questions and rules.

The software may also include instructions defining action items to be taken when the triggers are tripped, such as sending a report to a student, the students' parents, the instructor, or an administrator. The default instructions may further include instructions defining, for example, the survey questions to be included, and their associated thresholds/triggers, possibly according to the subject matter of the survey questions.

In some embodiments, the database of survey questions and triggers may be populated according to input by a course administrator. In these embodiments, the server may be configured to, and the instructions may cause the server to generate a Graphical User Interface (GUI) to be displayed on an administrator's client computing device.

This administrator GUI may include one or more GUI components that allow the administrator to input the survey questions and subject matter into the GUI, and define the associated thresholds and/or triggers that will cause an action item, such as a report or survey to be sent to the defined target recipients (a student, student's parents, instructor, or the administrator themselves).

As a non-limiting example, a course administrator may be in charge of multiple sections of a course, with multiple professors teaching the course. In some embodiments, the administrators' input may therefore be specific to a course. The administrator GUI may further provide GUI components allowing the administrator to update or modify existing “generic” questions provided by the software. The input received from the administrator GUI may then be received by the server and used to populate the database/data store.

In some embodiments, the database of survey questions and triggers may be input by a course instructor. In these embodiments, the server may be configured to, and the instructions may cause the server to generate a GUI to be displayed on an instructor's client computing device.

This instructor GUI may include one or more GUI components that allow the instructor to input the survey questions into the GUI, and define the associated thresholds and/or triggers that will cause an action item, similar to the administrator GUI described above. Furthermore, this instructor GUI may provide GUI components allowing the instructor to update or modify existing “generic” questions provided by the software, or input by the administrator.

In some embodiments, the trigger data provided by the software modules, administrator, and/or course instructor may define a trigger that causes a survey to be generated and transmitted through an electronic network to one or more student client devices at a regular interval. For example, since many instructors view their terms, semesters, quarters, etc. in terms of weeks, the instructions may cause the system to generate and transmit a survey to students twice a week, at the end of the week, at the end of every two weeks, and the like.

In some embodiments, the trigger data provided by the software modules, administrator, and/or course instructor may define a trigger/threshold that causes a survey to be generated and transmitted through an electronic network to one or more student client devices after a specific event. For example, the instructions (possibly using data input by the administrator or instructor) may cause the system to identify a defining event, such as an end of chapter or mid-term exam. The system may monitor the data associated with the course, and when the event has occurred, the system may generate and transmit a survey to the students.

In some embodiments, the trigger data provided by the software modules, administrator, and/or course instructor may define learning objectives, assignments, quizzes, tests, etc. related to subject matter that the administrator or instructor has identified as essential or core concepts for the course. The trigger data may further define a trigger that causes a survey to be generated and transmitted through an electronic network to one or more student client devices after an identified activity related to the essential or core concepts has taken place. For example, if an instructor were teaching an algebra course, a survey may be automatically sent after a review of general math principles (e.g., addition, subtraction, multiplication, division, etc.) to be sure the students have mastered these concepts before moving on to more complex subjects.

In some embodiments, the trigger data provided by the software modules, administrator, and/or course instructor may define a trigger that causes a survey to be generated and transmitted through an electronic network to one or more student client devices after changes to the course curriculum, For example, if an instructor has received negative feedback on a learning objective, class resource, assignment, quiz, test etc., and has changed this part of the course curriculum in an attempt to improve it, the instructions may cause the system automatically generate and transmit a survey to students when the new curriculum item is complete.

In some embodiments, the trigger data provided by the software modules, administrator, and/or course instructor may, in addition to a trigger data, receive threshold data defining a threshold beyond which the trigger is tripped. The trigger data may further define a trigger that causes a survey to be generated and transmitted through an electronic network to one or more student client devices when an assessment indicating a performance beyond the threshold. For example, the system may be configured to monitor incoming assessment data associated with a class or individual students, in relation to a learning objective, an assignment, a quiz, a test, or the like. As each of these assessments are received, the system may compare the assessments with the defined thresholds. If individual students, or the class average, etc., is beyond the pre-defined threshold, the system may automatically generate and transmit a survey to either the course as a whole, or to a random sampling of students in the course.

The trigger data is not limited to the examples above, and any combination of trigger data may be used to automatically generate and transmit surveys to the course or to a random sampling within the course. For example, an instructor may include a new curriculum item to test an essential concept (since survey data indicated that previous versions were unsuccessful), set a date that this should be tested, and monitor the performance of the students with the new curriculum item.

If the system determines that an event has occurred that trips the trigger according to the rules, the system may identify the action item associated with the trigger. For example, if the action item is for a report, the disclosed system may select the associated data (e.g., course performance or evaluation data) from the database, and generate a report for display on client machines for the student, student's parents, instructor, and/or administrator. If the associated class data indicates that the term has ended, the rules or logic within the trigger data may cause the system to aggregate all course data and/or previous report data into an aggregate report, and transmit the report through the electronic network to the target user.

If the action item is a survey, the instruction may cause the disclosed system to identify the subject matter for the survey, and identify all survey questions associated in the database with the subject matter. The system may then automatically generate a survey including the identified survey questions, and send the survey to the identified target users (e.g., students, or a random sampling of students, in the course).

The system may then receive the input from the target users, and store the results of the survey in the database. This data may then be reviewable (possibly as a report), by the course administrator or instructor.

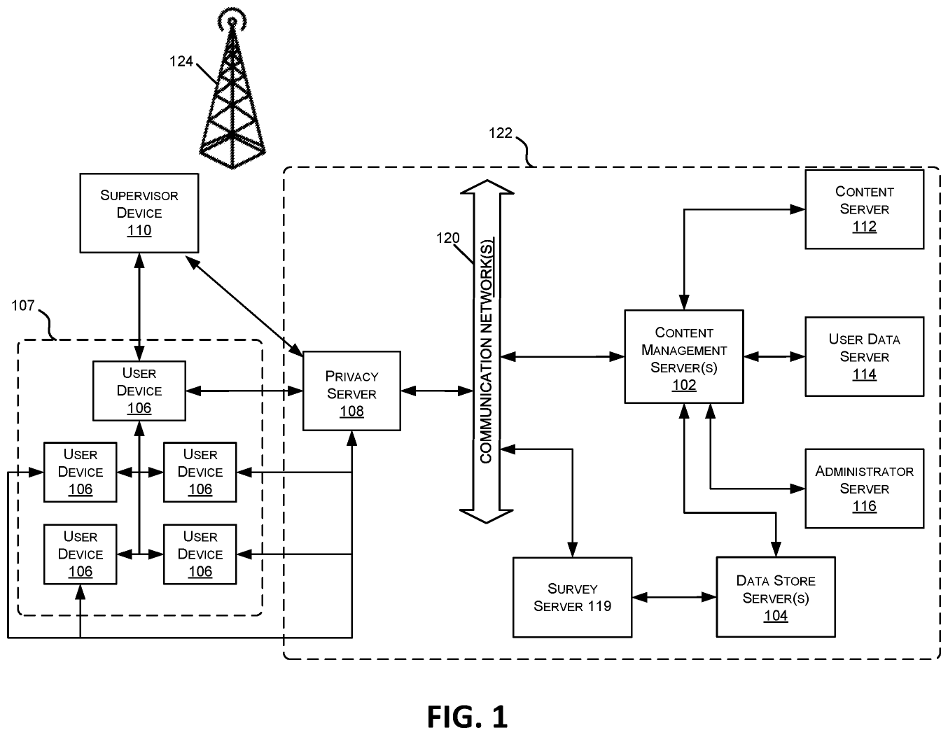

With reference now to FIG. 1, a block diagram is shown illustrating various components of a content distribution network (CDN) 100 which implements and supports certain embodiments and features described herein. Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, also referred to herein as “databases”, such as database servers and/or file-based storage systems.

The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatingly connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some embodiments, the one or several hardware and/or software components of the database server 104 can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

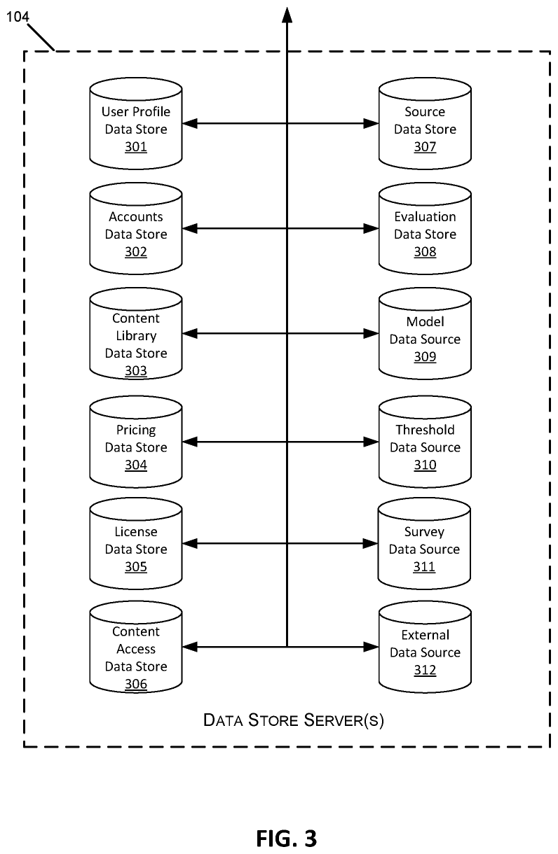

Databases 104 may comprise stored data relevant to the functions of the content distribution network 100. Illustrative examples of databases 104 that may be maintained in certain embodiments of the content distribution network 100 are described below in reference to FIG. 3. In some embodiments, multiple databases may reside on a single database server 104, either using the same storage components of server 104 or using different physical storage components to assure data security and integrity between databases. In other embodiments, each database may have a separate dedicated database server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming system, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include databases of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

In some embodiments, the hardware and software components may include an administrator client device and/or an instructor client device, which may be configured to receive and display an administrator or instructor GUI, respectively, generated by the content server 112, and displayed on the administrator or instructor client device, respectively. As non-limiting examples, this administrator GUI may be part of a client software running on the administrator or instructor client device and receiving instructions or other data from the content server 112, or may be an online software that displays the information received from the content server on a browser displayed on the administrator or instructor device.

As disclosed in greater detail herein, the administrator GUI and/or the instructor GUI may receive data from administrators and/or instructors relative to a teaching course. These GUIs may be used to receive course data to be stored in the data storage disclosed herein. As non-limiting examples, this course data may include course outlines, models, plans, syllabi, subject matter, class times, class locations, prerequisites, etc.

In some embodiments, the stored course data may further include data relevant to the instructor for the course. As non-limiting examples, this instructor data may further include course outlines for courses taught by the instructor, course evaluations from previous students, instructor qualifications, instructor availability for teaching courses, instructors' current teaching loads, etc.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

As a non-limiting example within the context of the disclosed embodiments, in addition to the course and instructor data disclosed above, the user data server 114 may receive and store data related to students within a course. As non-limiting examples, this data may include personal information about the students, previous evaluations and/or survey results received by the students, previous or current performance data for the students (e.g., attendance or participation in the course, course performance, such as scores for completed assignments, learning objectives, quizzes, tests, etc.), and the like.

Administrator server 116 may include hardware and software components to initiate various administrative functions at the content management server 102 and other components within the content distribution network 100. For example, the administrator server 116 may monitor device status and performance for the various servers, databases, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more survey servers 119. The survey server 119 may include hardware and software components to generate, store, and maintain the survey resources for distribution to user devices 106 and other devices in the network 100.

In some embodiments, the survey server 119 can be configured to generate and/or aggregate one or several surveys based on questions received from a user device 106 and/or a supervisor device 110.

The questions may include questions to be included in surveys. Each of the questions may be associated, within the survey database 311, with additional data including one or more software rules or logic that determines the usage of the survey questions. As non-limiting examples, the rules or logic may include a topic or subject matter associated with each survey question, which survey questions should be included in a survey associated with this subject matter, and the like.

Similarly, the rules or logic associated with each survey question may include an event or “trigger” (described in more detail below) that determines when an action item or survey should be generated and delivered to identified users (e.g., students, or a random sampling of students within a course), the subject matter associated with the survey, the questions associated with the survey, etc. In some embodiments, the associated rules/data logic may further include additional action items such as generating and transmitting a report of the results of the survey, or an aggregation of survey or other reports, possibly to an administrator, instructor, student, student's parents, etc.

In some embodiments, the rules/data logic received from the user device 106 may include one or more thresholds, received, and associated with received user data, course data, survey questions and/or associated rules/logic, which causes the system to monitor performance data (e.g., attendance, participation, learning objective evaluations, etc.), and if the evaluation data is beyond the defined threshold, a trigger causes an action item to be executed.

The aggregation of the survey questions and their associated rules/data logic (e.g., subject matter, triggers, thresholds) may be included and defined according to a survey software running within the system, and/or may be received as user input from an administrator and/or an instructor GUI generated by the survey software, as non-limiting examples.

Specifically, in some embodiments, the survey software running within the system may include a plurality of software modules that include pre-defined survey questions and their associated subject matter, rules, triggers, thresholds, etc. On installation of the software, the survey database 311, described in more detail below, may be populated with these “out of the box” questions and associated rules or data logic.

The survey software may also include instructions defining action items to be taken when the triggers are tripped, such as sending a report to a student or instructor, or generating and transmitting a survey to the appropriate target users defined within the rules. As a non-limiting example, the rules may dictate that a set of standard or generic questions are submitted to the class, or a random sampling of the class, at regular intervals (e.g., every 2 weeks), or after every test, for example. These more generic or general questions may include, as non-limiting examples, “Was the teacher available?” “Did they answer your questions?” “How is the delivery of the content?” “Are your questions being answered quickly?” etc.

In some embodiments, the survey questions and associated rules (e.g., evaluation instructions, triggers, thresholds, timing of generating and sending surveys, etc.), may be generated by user input received from the administrator or instructor GUI referred to above. For example, the aggregation of the survey questions and their associated rules may be defined through user input by a course administrator. In these embodiments, the instructions executed within the system may cause the system, possibly one or more software modules in the survey software, to generate a GUI to be displayed on an administrator's client computing device.

This administrator GUI may include one or more GUI components that allow the administrator to input the survey questions into the GUI, and define the associated logic, such as the associations (e.g., the course and/or subject matter), thresholds and/or triggers, for the system to execute an action item (e.g., a report to be sent to a student or instructor, a survey to be generated and sent to the students, etc.).

In some embodiments, the administrators' input may be specific to a course, such as an administrator overseeing multiple sections of the same course taught by multiple instructors, who wants the course to be taught consistently. In these embodiments, the administrator GUI may provide GUI components allowing the administrator to generate new survey questions and associated data, and/or update or modify existing “generic” questions provided by the software, in order to target specific issues that the administrator believes may be affecting the quality of the course. The administrator may therefore use the administrator GUI to input survey questions related to consistency within the various sections of the course, as well as the rules that define when the questions will be sent to those taking the survey. The input from the administrator GUI may be received by the server and used to populate the survey database/data store 311, described in more detail below.

In some embodiments, the survey questions, and their associated rules may be input by a course instructor. In these embodiments, the server may be configured to, and the instructions may cause the server to generate, a GUI to be displayed on an instructor's client computing device. This instructor GUI may include one or more GUI components that allow the instructor to input the survey questions into the GUI, and define the associated rules, thresholds, triggers etc. that will cause an action item, such as a report to be sent to a student or instructor, and/or to generate a survey to be sent to the students. Furthermore, this instructor GUI may provide GUI components allowing the instructor to update or modify existing generic or general questions provided by the software, or input by the administrator.

In some embodiments, the survey server 119 can be configured to generate and/or aggregate one or several surveys based on questions stored in a database in the database server 104. In some embodiments, the survey server 119 can send survey information to one or several of the user devices 106 and/or receive survey information from one or several of the user devices 106.

Specifically, in a non-limiting example, the survey server 119 may receive a notification that a trigger within the survey database 311 has been tripped, and/or that a threshold associated with a trigger has been crossed. The survey server 119 may then execute software instructions, rules, or other data logic, possibly stored in the survey database 311, to determine the subject matter associated with the trigger. The survey server 119 may then identify all of the survey questions and associated data in the survey database 311 related to the trigger, and may aggregate all associated survey questions into a survey. The survey server 119 may then generate a GUI for displaying the survey.

The survey server 119 may then identify, possibly using the user and/or course databases and/or data servers 114 described herein, one or more target recipient users (e.g., students within a class), or a random sampling of these target recipient users to whom the survey should be transmitted and transmit the GUI to one or more target recipients.

In some embodiments, the survey server 119 can be configured to receive, sort, and/or analyze some or all of the survey information received from the one or several user devices 106. In some embodiments, the survey server 119 can receive the survey information, classify the survey information, and direct the storage of the survey information within one or several of the databases of the database server 104 according to one or several attributes of the survey information. In some embodiments, these one or several attributes can, for example, relate to whether the survey information is of the type used for providing real-time feedback, or of the type that is not used for providing real-time feedback.

By way of example, in some embodiments, survey information can be received during, for example, a lecture, a class, or the like, and can be used to affect a portion of that lecture, class, or the like. In such an embodiment, the survey information can be analyzed to determine the effectiveness of the lecture, the class, or the like and feedback can be provided during the lecture, class, or the like based on the analysis of the survey data. As used herein, feedback is provided in real-time if feedback is provided before the completion of the lecture, class, or the like from which survey data was collected upon which the feedback is based.

In such an embodiment in which real-time feedback is desired, the speed with which the survey data is accessible and analyzable can determine whether timely, real-time feedback can be provided. Thus, in some embodiments, such survey information for which timely, real-time feedback may be desired can be directed for storage in a database located in a tier 0 or tier 1 memory, and survey information for which real-time feedback is not desired may be directed for storage in a database located in a lower tier memory.

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

In some embodiments, some of the components of the content distribution network 100 can be identified as being part of the back-end components 122. The back-end components 122 can include, for example, the content management server 102, the database server 1204, the privacy server 108, the content server 112, the user data server 114, the administrator server 116, and/or the communication network 120.

The content distribution network 100 may include one or several navigation systems or features including, for example, the Global Positioning System (“GPS”), GALILEO, or the like, or location systems or features including, for example, one or several transceivers that can determine location of the one or several components of the content distribution network 100 via, for example, triangulation. All of these are depicted as navigation system 124.

In some embodiments, navigation system 124 can include or several features that can communicate with one or several components of the content distribution network 100 including, for example, with one or several of the user devices 106 and/or with one or several of the supervisor devices 110. In some embodiments, this communication can include the transmission of a signal from the navigation system 124 which signal is received by one or several components of the content distribution network 100 and can be used to determine the location of the one or several components of the content distribution network 100.

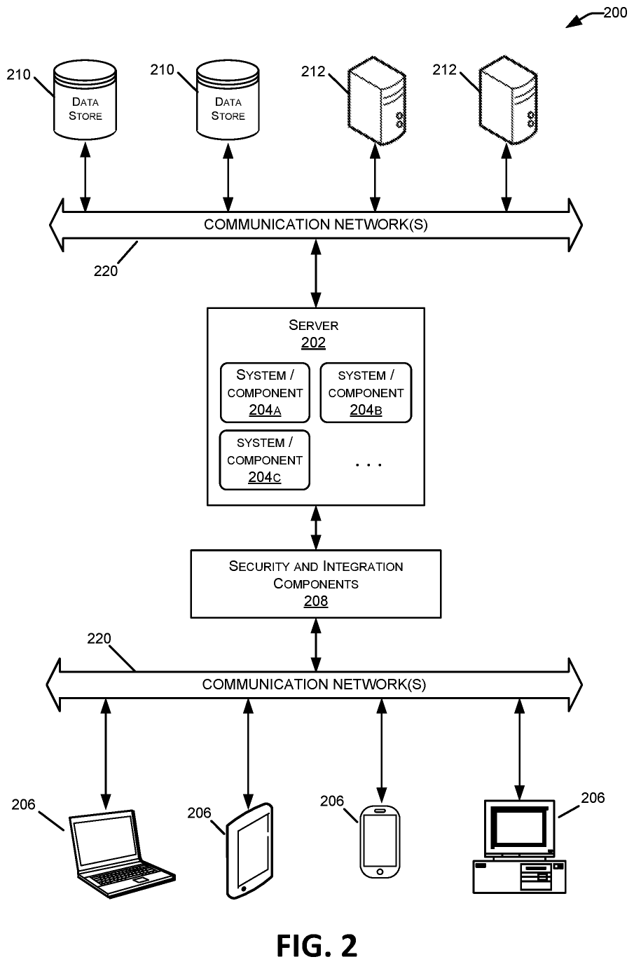

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. For example, some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard, which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more databases 210 and/or back-end servers 212. In certain examples, the databases 210 may correspond to database server(s) 104 discussed above in FIG. 1, and back-end servers 212 may correspond to the various back-end servers 112-116. Databases 210 and servers 212 may reside in the same datacenter or may operate at a remote location from server 202. In some cases, one or more databases 210 may reside on a non-transitory storage medium within the server 202. Other databases 210 and back-end servers 212 may be remote from server 202 and configured to communicate with server 202 via one or more networks 220. In certain embodiments, databases 210 and back-end servers 212 may reside in a storage-area network (SAN), or may use storage-as-a-service (STaaS) architectural model. In some embodiments, the computing environment can be replicated for each of the networks 107, 122, 104 discussed with respect to FIG. 1 above.

With reference to FIG. 3, an illustrative set of databases and/or database servers is shown, corresponding to the databases servers 104 of the content distribution network 100 discussed above in FIG. 1. One or more individual databases 301-312 may reside in storage on a single computer server 104 (or a single server farm or cluster) under the control of a single entity, or may reside on separate servers operated by different entities and/or at remote locations. In some embodiments, databases 301-312 may be accessed by the content management server 102 and/or other devices and servers within the network 100 (e.g., user devices 106, supervisor devices 110, administrator servers 116, etc.). Access to one or more of the databases 301-312 may be limited or denied based on the processes, user credentials, and/or devices attempting to interact with the database.

The paragraphs below describe examples of specific databases that may be implemented within some embodiments of a content distribution network 100. It should be understood that the below descriptions of databases 301-312, including their functionality and types of data stored therein, are illustrative and non-limiting. Database server architecture, design, and the execution of specific databases 301-312 may depend on the context, size, and functional requirements of a content distribution network 100. For example, in content distribution systems 100 used for professional training and educational purposes, separate databases or file-based storage systems may be implemented in database server(s) 104 to store trainee and/or student data, trainer and/or professor data, training module data and content descriptions, training results, evaluation data, and the like. In contrast, in content distribution systems 100 used for media distribution from content providers to subscribers, separate databases may be implemented in database server(s) 104 to store listing of available content titles and descriptions, content title usage statistics, subscriber profiles, account data, payment data, network usage statistics, etc.

A user profile data store 301, also referred to herein as a user profile database 301 may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some embodiments, this information can relate to one or several individual end users such as, for example, one or several students, content authors, teachers, administrators, or the like, and in some embodiments, this information can relate to one or several institutional end users such as, for example, one or several schools, groups of schools such as one or several school districts, one or several colleges, one or several universities, one or several training providers, or the like.

As a non-limiting example, the user profile data store 301 may include data about students within a class. This data may include a link to a course profile about the course in which the students are enrolled, student performance data for a current or past term, previous student evaluations of courses and instructors, and the like.

In some embodiments, this information can identify one or several user memberships in one or several groups such as, for example, a student's membership in a university, school, program, grade, course, class, or the like.

In some embodiments, the user profile database 301 can include information relating to a user's status, location, or the like. This information can identify, for example, a device a user is using, the location of that device, or the like. In some embodiments, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in-is active. In some embodiments, the information relating to the user's status can identify whether the user is currently accessing content and/or participating in an activity from the content distribution network 100.

In some embodiments, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some embodiments, this can include data identifying the type of information accessed through the content distribution network 100 and/or the type of activity performed by the user via the content distribution network 100, the lapsed time since the last time the user accessed content and/or participated in an activity from the content distribution network 100, or the like. In some embodiments, this information can relate to a content program comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with one or several supervisors and/or supervisor devices 110, or the like.

In some embodiments in which the one or several end users are individuals, and specifically are students, the user profile database 301 can further include information relating to a student's academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some embodiments, this information can be stored in a tier of memory that is not the fastest memory in the content distribution network 100.

The user profile database 301 can include information relating to one or several student learning preferences. In some embodiments, for example, the user, also referred to herein as the student or the student-user, may have one or several preferred learning styles, one or several most effective learning styles, and/or the like. In some embodiments, the students learning style can be any learning style describing how the student best learns or how the student prefers to learn. In one embodiment, these learning styles can include, for example, identification of the student as an auditory learner, as a visual learner, and/or as a tactile learner. In some embodiments, the data identifying one or several student learning styles can include data identifying a learning style based on the student's educational history such as, for example, identifying a student as an auditory learner when the student has received significantly higher grades and/or scores on assignments and/or in courses favorable to auditory learners. In some embodiments, this information can be stored in a tier of memory that is not the fastest memory in the content distribution network 100.

In some embodiments, the user profile database 301 can include information relating to one or several student-user behaviors including, for example: attendance in one or several courses; attendance and/or participation in one or several study groups; extramural, student group, and/or club involve and/or participation, or the like. In some embodiments, this information relating to one or several student-user behaviors can include information relating to the student-users schedule. In the context of the current invention, students' attendance and participation may be evaluated and compared to triggers/thresholds stored in the survey database 311, to determine whether surveys should be generated and sent to the students.

The user profile database 301 can further include information relating to one or several teachers and/or instructors who are responsible for organizing, presenting, and/or managing the presentation of information to the student. In some embodiments, user profile database 301 can include information identifying courses and/or subjects that have been taught by the teacher, data identifying courses and/or subjects currently taught by the teacher, and/or data identifying courses and/or subjects that will be taught by the teacher. In some embodiments, this can include information relating to one or several teaching styles of one or several teachers. In some embodiments, the user profile database 301 can further include information indicating past evaluations and/or evaluation reports received by the teacher. In some embodiments, the user profile database 301 can further include information relating to improvement suggestions received by the teacher, training received by the teacher, continuing education received by the teacher, and/or the like. In some embodiments, this information can be stored in a tier of memory that is not the fastest memory in the content distribution network 100.

An accounts datastore 302, also referred to herein as an accounts database 302, may generate and store account data for different users in various roles within the content distribution network 100. For example, accounts may be created in an accounts database 302 for individual end users, supervisors, administrator users, and entities such as companies or educational institutions. Account data may include account types, current account status, account characteristics, and any parameters, limits, restrictions associated with the accounts.

A content library datastore 303, also referred to herein as a content library database 303, may include information describing the individual content items (or content resources or data packets) available via the content distribution network 100. In some embodiments, the library database 303 may include metadata, properties, and other characteristics associated with the content resources stored in the content server 112. In some embodiments, this data can include the one or several items that can include one or several documents and/or one or several applications or programs. In some embodiments, the one or several items can include, for example, one or several webpages, presentations, papers, videos, charts, graphs, books, written work, figures, images, graphics, recordings, or any other document, or any desired software or application or component thereof including, for example, a graphical user interface (GUI), all or portions of a Learning Management System (LMS), all or portions of a Content Management System (CMS), all or portions of a Student Information Systems (SIS), or the like.

In some embodiments, the data in the content library database 303 may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library database 303 may be configured to allow updating of content metadata or properties, and to allow the addition and/or removal of information relating to the content resources. In some embodiments, the content library database 303 can be organized such that content is associated with one or several courses and/or programs in which the content is used and/or provided. In some embodiments, the content library database 303 can further include one or several teaching materials used in the course, a syllabus, one or several practice problems, one or several tests, one or several quizzes, one or several assignments, or the like. All or portions of the content library database can be stored in a tier of memory that is not the fastest memory in the content distribution network 100. For example, content relationships may be implemented as graph structures, which may be stored in the library data store 303 or in an additional store for use by selection algorithms along with the other metadata. In some embodiments, the administrator and/or instructor GUI described above may be used to receive data for syllabus, tests, assignments, etc.

In some embodiments, the content library database 303 can comprise information to facilitate in authoring new content. This information can comprise, for example, one or several specifications identifying attributes and/or requirements of desired newly authored content. In some embodiments, for example, a content specification can identify one or several of a subject matter; length, difficulty level, or the like for desired newly authored content.

In some embodiments, the content library database 303 can further include information for use in evaluating newly authored content. In some embodiments, this evaluation can comprise a determination of whether and/or the degree to which the newly authored content corresponds to the content specification, or some or all of the requirements of the content specification. In some embodiments, this information for use in evaluation newly authored content can identify or define one or several difficulty levels and/or can identify or define one or several acceptable difficulty levels. In some embodiments, for example, this information for use in evaluation newly authored content can define a plurality of difficulty levels and can delineate between these difficulty levels, and in some embodiments, this information for use in evaluation newly authored content can identify which of the defined difficulty levels are acceptable. In other embodiments, this information for use in evaluation newly authored content can merely include one or several definitions of acceptable difficulty levels, which acceptable difficulty level can be based on one or several pre-existing difficult measures such as, for example, an Item Response Theory (IRT) value such as, for example, an IRT b value, a p value indicative of the proportion of correct responses in a set of responses, a grade level, or the like.

In some embodiments, this information for use in evaluation newly authored content can further define one or several differentiation and/or discrimination levels and/or define one or several acceptable differentiation and/or discrimination levels or ranges. As used herein, “differentiation” and “discrimination” refer to the degree to which an item such as a question identifies low ability versus high ability users. In some embodiments, this information for use in evaluation newly authored content can identify one or several acceptable levels and/or ranges of discrimination which levels and/or ranges can be based on one or several currently existing discrimination measures such as, for example, a Point-Biserial Correlation.

A pricing database 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage and. In other cases, pricing may be tied to specific content resources. Certain content resources may have associated pricing information, whereas other pricing determinations may be based on the resources accessed, the profiles and/or accounts of the users, and the desired level of access (e.g., duration of access, network speed, etc.). Additionally, the pricing database 304 may include information relating to compilation pricing for groups of content resources, such as group prices and/or price structures for groupings of resources.

A license database 305 may include information relating to licenses and/or licensing of the content resources within the content distribution network 100. For example, the license database 305 may identify licenses and licensing terms for individual content resources and/or compilations of content resources in the content server 112, the rights holders for the content resources, and/or common or large-scale right holder information such as contact information for rights holders of content not included in the content server 112.

A content access database 306 may include access rights and security information for the content distribution network 100 and specific content resources. For example, the content access database 306 may include login information (e.g., user identifiers, logins, passwords, etc.) that can be verified during user login attempts to the network 100. The content access database 306 also may be used to store assigned roles and/or levels of access to users. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307, also referred to herein as a source database 307, may include information relating to the source of the content resources available via the content distribution network. For example, a source database 307 may identify the authors and originating devices of content resources, previous pieces of data and/or groups of data originating from the same authors or originating devices, and the like.

An evaluation data store 308, also referred to herein as an evaluation database 308, may include information used to direct the evaluation of users and content resources in the content management network 100. In some embodiments, the evaluation database 308 may contain, for example, the analysis criteria and the analysis guidelines for evaluating users (e.g., trainees/students, gaming users, media content consumers, etc.) and/or for evaluating the content resources in the network 100. The evaluation database 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation database 308 including data and/or instructions in the form of one or several electronic rubrics or scoring guides for use in the evaluation of the content, users, or applications. The evaluation database 308 also may include past evaluations and/or evaluation analyses for users, content, and applications, including relative rankings, characterizations, explanations, and the like.

A model data store 309, also referred to herein as a model database 309 can store information relating to one or several predictive models. In some embodiments, these one or several predictive models can be used to: generate a prediction of the risk of a student-user not achieving one or several predetermined outcomes; generate a prediction of a categorization of the student-user, which categorization can indicate an expected effect of one or several interventions on the student-user; and/or generate a prediction of a priority for any identified intervention.

In some embodiments, the risk model can comprise one or several predictive models based on, for example, one or several computer learning techniques. In some embodiments, the risk model can be used to generate a risk value for a student, which risk value characterizes the risk of the student-user not achieving the predetermined outcome such as, for example, failing to complete a course or course of study, failing to graduate, failing to achieve a desired score or grade, or the like. In some embodiments, the risk model can comprise, for example, a decision tree learning model. In some embodiments, the risk model can generate the risk value through the inputting of one or several parameters, which parameters can be one or several values, into the risk model. These parameters can be generated based on one or several features or attributes of the student-user. The risk model, having received the input parameters, can then generate the risk value.

In some embodiments, the categorization model can determine a category of the student-user. In some embodiments, the categorization model can be used to generate one or several categorization values or identifiers that identify a category of the student-user. In some embodiments, this category can correspond to a likelihood of an intervention increasing or decreasing the risk value. In some embodiments, the categories can comprise a first category in which an intervention decreases the risk value, a second category in which an intervention increases the risk value, and a third category in which an intervention will not affect the risk value. In some embodiments, this third category can be further divided into a first group in which the student-users will likely fail to achieve the desired outcome regardless of intervention, and a second group in which the student-users will likely achieve the desired outcome regardless of intervention. In some embodiments, the categorization model can determine the category of the student-user through the input of one or several parameters relevant to the student-user into the categorization model. In some embodiments, these parameters can be generated from one or several features or attributes of the student-user that can be, for example, extracted from data relating to the student-user.

In some embodiments, the priority model can determine a priority value, which can be a prediction of the importance of any determined intervention. In some embodiments, this priority model can be determined based on information relating to the student-user for which the priority value is determined. In some embodiments, this priority value can be impacted by, for example, the value of the course associated with the risk value. In some embodiments, for example, the priority value may indicate a lower priority for a risk in a non-essential course. In such an embodiment, priority can be determined based on the credits of a course, based on the relevance of a course to, for example, a degree or major, based on the role of the course as a pre-requisite to subsequent courses, or the like.

A dashboard database 310 can include information for generating a dashboard. In some embodiments, this information can identify one or several dashboard formats and/or architectures. As used herein, a format refers to how data is presented in a web page, and an architecture refers to the data included in the web page and the format of that data. In some embodiments, the dashboard database 310 can comprise one or several pointers to other databases for retrieval of information for inclusion in the dashboard. Thus, in one embodiment, the dashboard database 310 can comprise a pointer to all or portions of the user profile database 301 to direct extraction of data from the user profile database 301 for inclusion in the dashboard.

A survey database 311 may include information relating to one or several surveys. In some embodiments, this can include information relating to the providing of one or several surveys and/or information gathered in response to one or several surveys.

The information relating to providing one or several surveys can include, for example, information comprising one or several surveys and/or one or several questions, information identifying one or several survey recipients including, for example, one or several individual recipients or one or several groups of recipients such as, for example, one or several classes or portions of one or several classes (e.g., a random sampling of students within one or several groups of recipients), one or several frequencies for providing surveys, or the like.

In some embodiments, the survey database 311 can include information identifying when to provide a survey, which information can include, for example, one or several triggers and one or several associated thresholds, also referred to herein as trigger thresholds.

The triggers within the disclosed embodiments may comprise rules, logic, and/or instructions within the system and/or stored within data storage, and used to determine when to automatically execute certain action items within the disclosed system, such as generating a report or survey, and transmitting them to identified target users. Several examples demonstrating types of triggers are disclosed below.

The combination of survey questions and/or their associated triggers, rules, or logic may be used by an instructor or administrator to determine issues within a course. As a non-limiting example, the administrator or instructor of a course may use the triggers and survey questions to determine whether poor performance in the course is caused by the instructor's technique, the course materials, course students' lack of understanding of the course subject matter, students' personal issues interfering with the course, etc.

As disclosed above, the course administrator and/or instructor may contribute to a pool of survey questions and their associated rules or logic, by accessing an administrator or instructor GUI, which receives input from the administrator or instructor defining the survey questions, and their associated rules or logic. These survey questions and associated rules may be received by the survey server 119, and stored in the survey data store 311.

In some embodiments, one or more survey software modules may populate a set of general or generic survey questions, as well as their associated rules or other data, within survey data store 311. In these embodiments, the administrator or instructor may use the appropriate GUI to either update or add to this pool of survey questions and associated data. In some embodiments, therefore, the survey questions and data may be structured to become more and more specific to determine the source of the issues and any reasons for changes in course performance.

In some embodiments, the triggers may be defined in such as a way as to cause a survey to be automatically generated and transmitted through an electronic network to one or more student client devices at a regular interval. For example, since many instructors break down their course outline for the semester, quarter, etc. in terms of weeks, the instructions may cause the system to generate and transmit a survey to students twice a week, at the end of the week, at the end of every two weeks, and the like.

In some embodiments, the triggers may be defined in such a way as to cause a survey to be automatically generated and transmitted through an electronic network to one or more student client devices after a specific event. For example, the instructions (possibly using data input by the administrator/instructor) may cause the system to identify a defining event, such as an end of chapter or mid-term exam. The system may monitor the course data associated with the course, and when the event has occurred, the system may automatically generate and transmit a survey to the students.

In some embodiments, the course data may include identification of distinctions between essential (i.e., critical points of learning) and non-essential course material for a course, In these embodiments, the triggers may be linked to a course data or activity (e.g., learning objectives, assignments, quizzes, tests, etc.), which have been identified as a course administrator or instructor as being related to subject matter that the administrator or instructor has identified as essential or core concepts for the course (e.g., flagged them as associated with essential points of learning, when entering the associated survey question data). The trigger may therefore be defined in such a way as to cause a survey to be automatically generated and transmitted through an electronic network when an activity related to the essential or core concept has been completed by course students. For example, if an instructor were teaching an algebra course, a survey may be automatically sent after a review of general math principles (e.g., addition, subtraction, multiplication, division, etc.).

Similarly, survey questions and their associated triggers or other rules may be tied to learning objectives, making sure that essential learning objectives are mastered by and clear to students. For example, students may identify, through survey questions, a lukewarm response to the content delivery for certain critical learning objective items. Such a lukewarm responses may be an indication that the student struggled with that central concept. For example, a B average in the class for learning objectives (assignments, quizzes, tests, etc.) around these central concepts may indicate hesitancy in understanding of the material. This would not be a negative per se, but as a critical learning concept, it's important that the students understand. The instructor would want to identify the source of the hesitancy, and in response, the instructor may want to go over it again to make sure everyone is getting it. For example, the instructor may identify videos, handouts, etc.

In some embodiments, the triggers may be defined in such a way as to cause a survey to be generated and transmitted through an electronic network to one or more student client devices after changes to the course curriculum, For example, if an instructor has received negative feedback on a learning objective, assignment, quiz, test etc. for the course, and has changed this part of the course curriculum in an attempt to improve it, the instructions may cause the system to automatically generate and transmit a survey to students when the new curriculum item is complete.

In some embodiments, the data associated with the survey questions and the trigger may include a threshold associated with the survey question or trigger. Thus, the trigger may be defined in such a way as to cause a survey to be generated and transmitted through an electronic network to one or more student client devices when a performance of one or more students, or the class as a whole, is beyond the pre-defined threshold.

For example, the system may be configured to monitor incoming data associated with a class or individual students. As each of these inputs are received, the system may assess the input (e.g., automatically grade an assignment, quiz, test, etc.) and compare the assessment with the defined thresholds defined within the system. If individual students' performance, or the class average, etc., falls outside of the pre-defined threshold, the system may automatically generate and transmit a survey. The survey may be transmitted to the class as a whole, or to a random sampling within the class.

As a non-limiting example, the performance of an entire class for a single event may be monitored, such as a quiz given to all of the students within a course. If there is a high fail rate for the quiz, the system may automatically generate and transmit a survey for a random sampling of the course to determine if this information was covered, whether or not the content was explained well, etc.

In some embodiments, these triggers can include, for example, a change in attendance and/or participation, including a decrease in attendance and/or participation, an increase in attendance and/or participation, attendance and/or participation above or below a threshold level, or the like, a change in student comprehension as indicated by a change in grades, performance, or the like, a change in positive and/or negative references to a class and/or teacher in social media, or the like.

The example triggers above are not exclusive from one another; any of the above may be combined. For example, an instructor may include a new item to test an essential concept, since previous versions were unsuccessful, set a date that this should be tested, and monitor the performance of the students with the new item.

In some embodiments, the information gathered in response to the one or several surveys can include, for example, user provided answers to one or several surveys, one or several survey questions, or the like. In some embodiments, this information can be linked to the user source of the information, and in some embodiments, this information can be separated from the user source of the information.

The survey information database 311 can comprise a single database or a plurality of databases such as, for example, a question database and/or a trigger database. In some embodiments, the question database can include a plurality of questions that can be organized according to one or several parameters. These parameters can include, one or several associated triggers, one or several levels of specificity, and/or one or several questioned subject matter. Thus, in some embodiments, some or all of the questions in the question database can be associated with a value linking the each of the some or all of the questions with one or several triggers stored in the trigger database.

Further, each of the questions can include a value associating the question with a questioned subject matter, which question subject matter can be, for example, an area of the course about which the question is intended to gather information via student response. These areas of the course can include, for example, the teacher's teaching style (i.e. how the teacher is teaching), the appropriateness/successfulness of the course assignments, the quality and/or value of the course content, and/or the teacher's approach and/or interaction with one or several students. The question database can further include one or several values identifying the specificity of each question in the question database. This value identifying specificity can result in the creation of a tree-like structure of questions, with some trunk-questions identified as being directed to broad areas, and other branch-questions identified as being directed to one or several portions of the broad areas identified by one or several of the trunk-questions. This tree-like structure can contain multiple levels of child-questions directed to a portion of the subject area of their parent questions, and these multiple levels can be repeated until a desire level of specificity is attained.

In some embodiments, the entirety of the data contained in the survey information database 311 can be stored in a single memory such as, for example, within a single memory tier, and in some embodiments, the data contained in the survey information database 311 can be stored in multiple memories such as, for example, within multiple tiers of memory. In some embodiments, dividing the data contained in the survey information database 311 into multiple tiers of memory can allow efficient use of storage resources by placing items that are desired to be quickly accessible in lower tiers than information that is not desired to be as quickly accessible.

The survey database 311 can include information identifying the student's performance in evaluating the teacher, the course, and/or the course material, as well as identifying the student's performance in academic portions of the class. In some embodiments, the survey database 311 includes information identifying the student's performance evaluating the teacher, course, and/or the course material and does not include information relating to the student's academic performance. This data may indicate the amount of time spent by the student in completing past surveys, indicate the number of written comments, or the like.

The survey database 311 can include one or several evaluations and/or evaluation reports. In some embodiments, the evaluations and/or evaluation reports can be an aggregate of data relating to teacher performance, material performance, and/or course performance.

In some embodiments, the survey database 311 can include information relating to provided feedback relating to a teacher, a course, and/or learning materials. In some embodiments, for example, this feedback can include one or several recommendations, including, for example, one or several recommended additional and/or replacement materials, one or several material changes, one or several recommended teacher improvement resources such as, for example, papers, books, courses, training, seminars, or the like, which improvement resources can relate to management, organization, speaking, educational and/or instructional techniques, or the like.

The data received for the evaluation reports may be used by the institution, course administrators, and/or course instructors to identify the source of issues within the course. In one non-limiting example, in a course that include several instructors using the same materials, the generated reports based on the survey responses may indicate positive feedback for the course materials, but negative feedback for the course overall. In this scenario, the administrators and/or instructors may conclude that the data weighs in favor of the problem being with the instructor and/or delivery style of the content, rather than the course materials and/or individual students themselves. In these embodiments, the system, possibly including the recommendation engine, may be configured to generate, within the report, a recommendation to change the delivery style of the contents of the course.

In a similar example, if a course includes a learning objective for the course that has been updated or replaced from recent terms for the course, and if each of the students within the course is associated in data storage with the learning objective, the system may monitor the results of the change, and determine that the causes for negative feedback in the course are tied to the changed course content. In this scenario, the report may recommend to the administrators or the instructors that the changes to the course content be either changed back or replaced.

In some embodiments, the survey database 311 can be divided into a first portion comprising first memory components and a second portion comprising second memory components. In some embodiments, the first portion can comprise relatively faster memory components and the second portion can comprise relatively slower memory components. Thus, in one embodiment, the first portion can comprise tier 0 or tier 1 memory components and the second portion can comprise tier 1 or tier 2 memory components. In some embodiments, data from the survey database 311 can be divided between the first and second portions based on whether the data is used for real-time analysis. Thus, data used for real-time analysis can be stored in the first portion and data that is not used for real-time analysis can be stored in the second portion. In one such embodiment a set of the triggers from the trigger database that can be used to indicate a time-sensitive desire for providing a survey can be stored within the first portion of the survey database 311, and a set of the triggers from the trigger database that can be used to indicate a non-time-sensitive desire for providing a survey can be stored within the second portion of the survey database 311.

In addition to the illustrative databases described above, database server(s) 104 may include one or more external data aggregators 312. External data aggregators 312 may include third-party data sources accessible to the content management network 100, but not maintained by the content management network 100. External data aggregators 312 may include any electronic information source relating to the users, content resources, or applications of the content distribution network 100. For example, external data aggregators 312 may be third-party databases containing demographic data, education related data, consumer sales data, health related data, and the like. Illustrative external data aggregators 312 may include, for example, social networking web servers, public records databases, learning management systems, educational institution servers, business servers, consumer sales databases, medical record databases, etc. Data retrieved from various external data aggregators 312 may be used to verify and update user account information, suggest user content, and perform user and content evaluations.

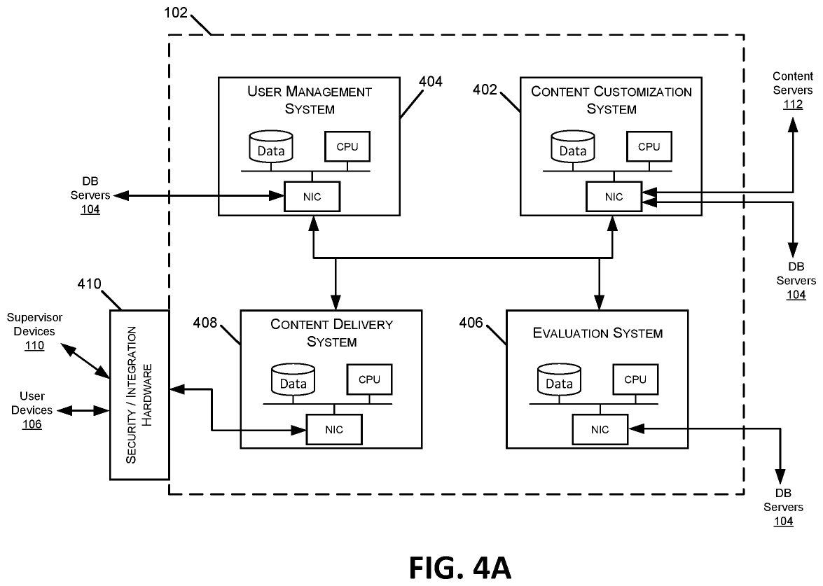

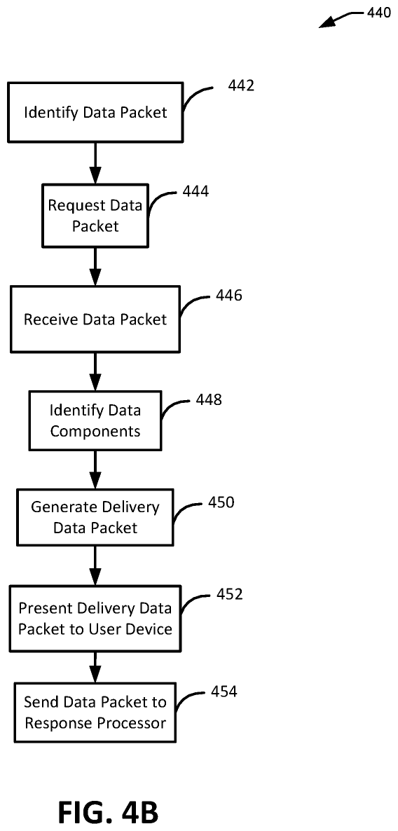

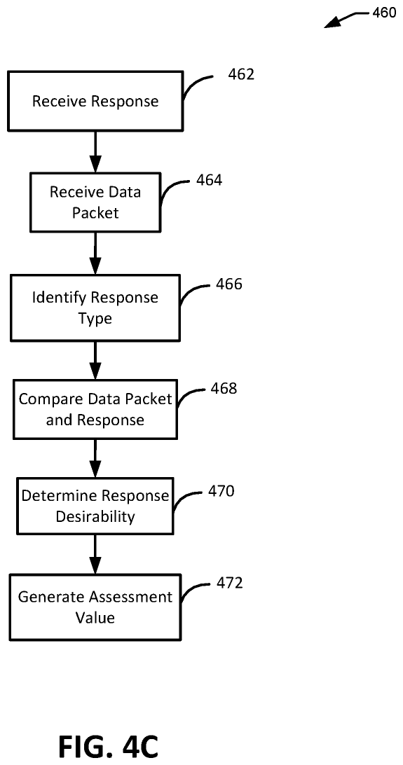

With reference now to FIG. 4, a block diagram is shown illustrating an embodiment of one or more content management servers 102 within a content distribution network 100. As discussed above, content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a content customization system 402. The content customization system 402 may be implemented using dedicated hardware within the content distribution network 100 (e.g., a content customization server 402), or using designated hardware and software resources within a shared content management server 102. In some embodiments, the content customization system 402 may adjust the selection and adaptive capabilities of content resources to match the needs and desires of the users receiving the content. For example, the content customization system 402 may query various databases and servers 104 to retrieve user information, such as user preferences and characteristics (e.g., from a user profile database 301), user access restrictions to content recourses (e.g., from a content access database 306), previous user results and content evaluations (e.g., from an evaluation database 308), and the like. Based on the retrieved information from databases 104 and other data sources, the content customization system 402 may modify content resources for individual users.

In some embodiments, the content management system 402 can include a recommendation engine, also referred to herein as an adaptive recommendation engine. In some embodiments, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In one embodiment, for example, the recommendation engine can retrieve information from the user profile database 301 identifying, for example, a skill level of the user. The recommendation engine can further retrieve information from the content library database 303 identifying, for example, potential data packets for providing to the user and the difficulty of those data packets and/or the skill level associated with those data packets.

The recommendation engine can use the evidence model to generate a prediction of the likelihood of one or several users providing a desired response to some or all of the potential data packets. In some embodiments, the recommendation engine can pair one or several data packets with selection criteria that may be used to determine which packet should be delivered to a student-user based on one or several received responses from that student-user. In some embodiments, one or several data packets can be eliminated from the pool of potential data packets if the prediction indicates either too high a likelihood of a desired response or too low a likelihood of a desired response. In some embodiments, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a user management system 404. The user management system 404 may be implemented using dedicated hardware within the content distribution network 100 (e.g., a user management server 404), or using designated hardware and software resources within a shared content management server 102. In some embodiments, the user management system 404 may monitor the progress of users through various types of content resources and groups, such as media compilations, courses or curriculums in training or educational contexts, interactive gaming environments, and the like. For example, the user management system 404 may query one or more databases and servers 104 to retrieve user data such as associated content compilations or programs, content completion status, user goals, results, and the like.

A content management server 102 also may include an evaluation system 406. The evaluation system 406 may be implemented using dedicated hardware within the content distribution network 100 (e.g., an evaluation server 406), or using designated hardware and software resources within a shared content management server 102. The evaluation system 406 may be configured to receive and analyze information from user devices 106. For example, various ratings of content resources submitted by users may be compiled and analyzed, and then stored in a database (e.g., a content library database 303 and/or evaluation database 308) associated with the content. In some embodiments, the evaluation server 406 may analyze the information to determine the effectiveness or appropriateness of content resources with, for example, a subject matter, an age group, a skill level, or the like. In some embodiments, the evaluation system 406 may provide updates to the content customization system 402 or the user management system 404, with the attributes of one or more content resources or groups of resources within the network 100. The evaluation system 406 also may receive and analyze user evaluation data from user devices 106, supervisor devices 110, and administrator servers 116, etc. For instance, evaluation system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some embodiments, the evaluation system 406 can be further configured to receive one or several responses from the user and to determine whether the one or several response are correct responses, also referred to herein as desired responses, or are incorrect responses, also referred to herein as undesired responses. In some embodiments, one or several values can be generated by the evaluation system 406 to reflect user performance in responding to the one or several data packets. In some embodiments, these one or several values can comprise one or several scores for one or several responses and/or data packets.

A content management server 102 also may include a content delivery system 408. The content delivery system 408 may be implemented using dedicated hardware within the content distribution network 100 (e.g., a content delivery server 408), or using designated hardware and software resources within a shared content management server 102. The content delivery system 408 can include a presentation engine that can be, for example, a software module running on the content delivery system.

The content delivery system 408, also referred to herein as the presentation module or the presentation engine, may receive content resources from the content customization system 402 and/or from the user management system 404, and provide the resources to user devices 106. The content delivery system 408 may determine the appropriate presentation format for the content resources based on the user characteristics and preferences, and/or the device capabilities of user devices 106. If needed, the content delivery system 408 may convert the content resources to the appropriate presentation format and/or compress the content before transmission. In some embodiments, the content delivery system 408 may also determine the appropriate transmission media and communication protocols for transmission of the content resources.

In some embodiments, the content delivery system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

With reference now to FIG. 4B, a flowchart illustrating one embodiment of a process 440 for data management is shown. In some embodiments, the process 440 can be performed by the content management server 102, and more specifically by the content delivery system 408 and/or by the presentation module or presentation engine. The process 440 begins at block 442, wherein a data packet is identified. In some embodiments, the data packet can be a data packet for providing to a student-user, and the data packet can be identified by determining which data packet to next provide to the user such as the student-user. In some embodiments, this determination can be performed by the content customization system 402 and/or the recommendation engine.

After the data packet has been identified, the process 440 proceeds to block 444, wherein the data packet is requested. In some embodiments, this can include the requesting of information relating to the data packet such as the data forming the data packet. In some embodiments, this information can be requested from, for example, the content library database 303. After the data packet has been requested, the process 440 proceeds to block 446, wherein the data packet is received. In some embodiments, the data packet can be received by the content delivery system 408 from, for example, the content library database 303.

After the data packet has been received, the process 440 proceeds to block 448, wherein one or several data components are identified. In some embodiments, for example, the data packet can include one or several data components which can, for example, contain different data. In some embodiments, one of these data components, referred to herein as a presentation component, can include content for providing to the student user, which content can include one or several requests and/or questions and/or the like. In some embodiments, one of these data components, referred to herein as a response component, can include data used in evaluating one or several responses received from the user device 106 in response to the data packet, and specifically in response to the presentation component and/or the one or several requests and/or questions of the presentation component. Thus, in some embodiments, the response component of the data packet can be used to ascertain whether the user has provided a desired response or an undesired response.

After the data components have been identified, the process 440 proceeds to block 450, wherein a delivery data packet is identified. In some embodiments, the delivery data packet can include the one or several data components of the data packets for delivery to a user such as the student-user via the user device 106. In some embodiments, the delivery packet can include the presentation component, and in some embodiments, the delivery packet can exclude the response packet. After the delivery data packet has been generated, the process 440 proceeds to block 452, wherein the delivery data packet is presented to the user device 106. In some embodiments, this can include providing the delivery data packet to the user device 106 via, for example, the communication network 120.

After the delivery data packet has been provided to the user device, the process 440 proceeds to block 454, wherein the data packet and/or one or several components thereof is sent to and/or provided to the response processor. In some embodiments, this sending of the data packet and/or one or several components thereof to the response processor can include receiving a response from the student-user, and sending the response to the student-user to the response processor simultaneous with the sending of the data packet and/or one or several components thereof to the response processor. In some embodiments, for example, this can include providing the response component to the response processor. In some embodiments, the response component can be provided to the response processor from the content delivery system 408.

With reference now to FIG. 4C, a flowchart illustrating one embodiment of a process 460 for evaluating a response is shown. In some embodiments, the process can be performed by the evaluation system 406. In some embodiments, the process 460 can be performed by the evaluation system 406 in response to the receipt of a response from the user device 106.

The process 460 begins at block 462, wherein a response is received from, for example, the user device 106 via, for example, the communication network 120. After the response has been received, the process 460 proceeds to block 464, wherein the data packet associated with the response is received. In some embodiments, this can include receiving all or one or several components of the data packet such as, for example, the response component of the data packet. In some embodiments, the data packet can be received by the response processor from the presentation engine.

After the data packet has been received, the process 460 proceeds to block 466, wherein the response type is identified. In some embodiments, this identification can be performed based on data, such as metadata associated with the response. In other embodiments, this identification can be performed based on data packet information such as the response component.

In some embodiments, the response type can identify one or several attributes of the one or several requests and/or questions of the data packet such as, for example, the request and/or question type. In some embodiments, this can include identifying some or all of the one or several requests and/or questions as true/false, multiple choice, short answer, essay, or the like.

After the response type has been identified, the process 460 proceeds to block 468, wherein the data packet and the response are compared to determine whether the response comprises a desired response and/or an undesired response. In some embodiments, this can include comparing the received response and the data packet to determine if the received response matches all or portions of the response component of the data packet, to determine the degree to which the received response matches all or portions of the response component, to determine the degree to which the receive response embodies one or several qualities identified in the response component of the data packet, or the like. In some embodiments, this can include classifying the response according to one or several rules. In some embodiments, these rules can be used to classify the response as either desired or undesired. In some embodiments, these rules can be used to identify one or several errors and/or misconceptions evidenced in the response. In some embodiments, this can include, for example: use of natural language processing software and/or algorithms; use of one or several digital thesauruses; use of lemmatization software, dictionaries, and/or algorithms; or the like.

After the data packet and the response have been compared, the process 460 proceeds to block 470 wherein response desirability is determined. In some embodiments this can include, based on the result of the comparison of the data packet and the response, whether the response is a desired response or is an undesired response. In some embodiments, this can further include quantifying the degree to which the response is a desired response. This determination can include, for example, determining if the response is a correct response, an incorrect response, a partially correct response, or the like. In some embodiments, the determination of response desirability can include the generation of a value characterizing the response desirability and the storing of this value in one of the databases 104 such as, for example, the user profile database 301. After the response desirability has been determined, the process 460 proceeds to block 472, wherein an assessment value is generated. In some embodiments, the assessment value can be an aggregate value characterizing response desirability for one or more a plurality of responses. This assessment value can be stored in one of the databases 104 such as the user profile database 301.

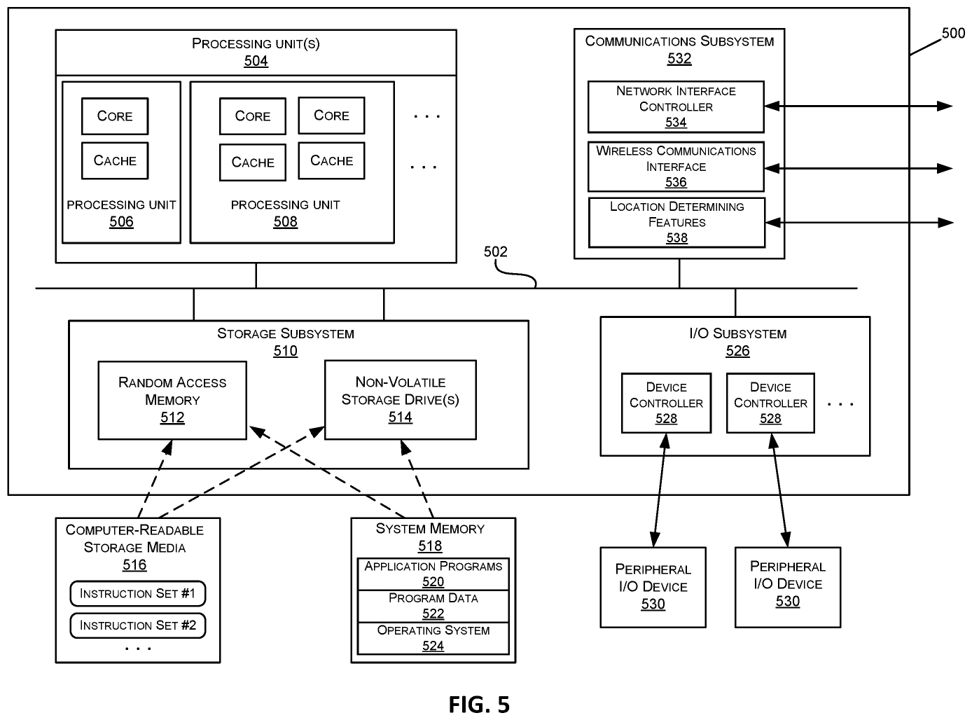

With reference now to FIG. 5, a block diagram of an illustrative computer system is shown. The system 500 may correspond to any of the computing devices or servers of the content distribution network 100 described above, or any other computing devices described herein, and specifically can include, for example, one or several of the user devices 106, the supervisor device 110, and/or any of the servers 102, 104, 108, 112, 114, 116. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500. The I/O subsystem 526 may provide one or several outputs to a user by converting one or several electrical signals to user perceptible and/or interpretable form, and may receive one or several inputs from the user by generating one or several electrical signals based on one or several user-caused interactions with the I/O subsystem such as the depressing of a key or button, the moving of a mouse, the interaction with a touchscreen or trackpad, the interaction of a sound wave with a microphone, or the like.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 318 may be stored in volatile memory (such as random access memory (RAM) 512) and/or in non-volatile storage drives 514 (such as read-only memory (ROM), flash memory, etc.) The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 300 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. As illustrated in FIG. 5, the communications subsystem 532 may include, for example, one or more location determining features 538 such as one or several navigation system features and/or receivers, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., data aggregators 312). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more databases 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

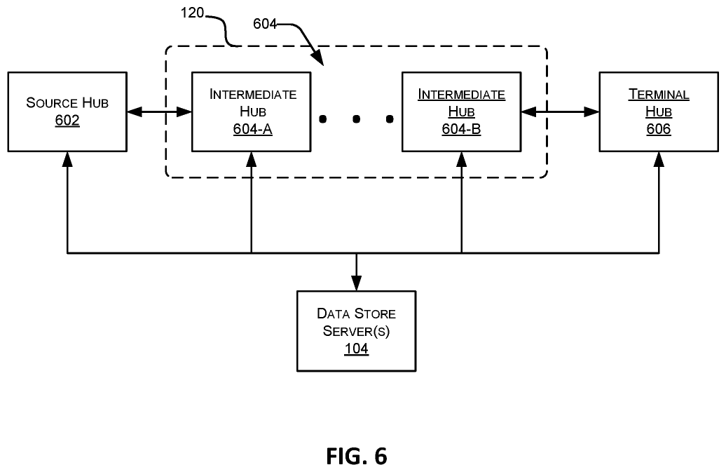

With reference now to FIG. 6, a block diagram illustrating one embodiment of the communication network is shown. Specifically, FIG. 6 depicts one hardware configuration in which messages are exchanged between a source hub 602 via the communication network 120 that can include one or several intermediate hubs 604. In some embodiments, the source hub 602 can be any one or several components of the content distribution network generating and initiating the sending of a message, and the terminal hub 606 can be any one or several components of the content distribution network 100 receiving and not re-sending the message. In some embodiments, for example, the source hub 602 can be one or several of the user device 106, the supervisor device 110, and/or the server 102, and the terminal hub 606 can likewise be one or several of the user device 106, the supervisor device 110, and/or the server 102. In some embodiments, the intermediate hubs 604 can include any computing device that receives the message and resends the message to a next node.

As seen in FIG. 6, in some embodiments, each of the hubs 602, 604, 606 can be communicatingly connected with the data store 104. In such an embodiments, some or all of the hubs 602, 604, 606 can send information to the data store 104 identifying a received message and/or any sent or resent message. This information can, in some embodiments, be used to determine the completeness of any sent and/or received messages and/or to verify the accuracy and completeness of any message received by the terminal hub 606.

In some embodiments, the communication network 120 can be formed by the intermediate hubs 604. In some embodiments, the communication network 120 can comprise a single intermediate hub 604, and in some embodiments, the communication network 120 can comprise a plurality of intermediate hubs. In one embodiment, for example, and as depicted in FIG. 6, the communication network 120 includes a first intermediate hub 604-A and a second intermediate hub 604-B.

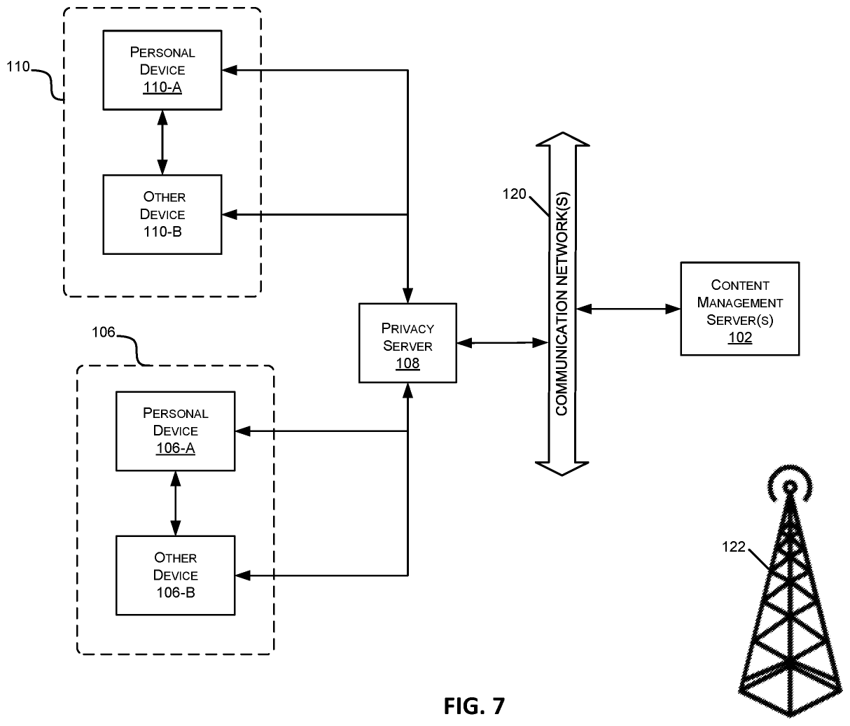

With reference now to FIG. 7, a block diagram illustrating one embodiment of user device 106 and supervisor device 110 communication is shown. In some embodiments, for example, a user may have multiple devices that can connect with the content distribution network 100 to send or receive information. In some embodiments, for example, a user may have a personal device such as a mobile device, a Smartphone, a tablet, a Smartwatch, a laptop, a PC, or the like. In some embodiments, the other device can be any computing device in addition to the personal device. This other device can include, for example, a laptop, a PC, a Smartphone, a tablet, a Smartwatch, or the like. In some embodiments, the other device differs from the personal device in that the personal device is registered as such within the content distribution network 100 and the other device is not registered as a personal device within the content distribution network 100.

Specifically with respect to FIG. 7, the user device 106 can include a personal user device 106-A and one or several other user devices 106-B. In some embodiments, one or both of the personal user device 106-A and the one or several other user devices 106-B can be communicatingly connected to the content management server 102 and/or to the navigation system 122. Similarly, the supervisor device 110 can include a personal supervisor device 110-A and one or several other supervisor devices 110-B. In some embodiments, one or both of the personal supervisor device 110-A and the one or several other supervisor devices 110-B can be communicatingly connected to the content management server 102 and/or to the navigation system 122.

In some embodiments, the content distribution network can send one or more alerts to one or more user devices 106 and/or one or more supervisor devices 110 via, for example, the communication network 120. In some embodiments, the receipt of the alert can result in the launching of an application within the receiving device, and in some embodiments, the alert can include a link that, when selected, launches the application or navigates a web-browser of the device of the selector of the link to page or portal associated with the alert.

In some embodiments, for example, the providing of this alert can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this alert can include determining an active device of the devices 106, 110 based on determining which of the devices 106, 110 and/or accounts are actively being used, and then providing the alert to that active device.

Specifically, if the user is actively using one of the devices 106, 110 such as the other user device 106-B and the other supervisor device 110-B, and/or accounts, the alert can be provided to the user via that other device 106-B, 110-B and/or account that is actively being used. If the user is not actively using another device 106-B, 110-B and/or account, a personal device 106-A, 110-A device, such as a smart phone or tablet, can be identified and the alert can be provided to this personal device 106-A, 110-A. In some embodiments, the alert can include code to direct the recipient device to provide an indicator of the received alert such as, for example, an aural, tactile, or visual indicator of receipt of the alert.

In some embodiments, the recipient device 106, 110 of the alert can provide an indication of receipt of the alert. In some embodiments, the presentation of the alert can include the control of the I/O subsystem 526 to, for example, provide an aural, tactile, and/or visual indicator of the alert and/or of the receipt of the alert. In some embodiments, this can include controlling a screen of the supervisor device 110 to display the alert, data contained in alert and/or an indicator of the alert.

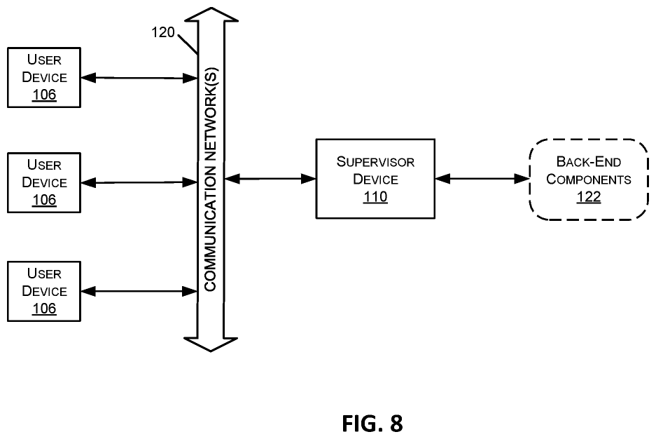

With reference now to FIG. 8, a block diagram illustrating one embodiment of the connection of user devices 106 to a supervisor device 110 is shown. In some embodiments, one or several of the user devices 106 can be connected to a supervisor device 110 in a classroom environment and/or to form a virtual classroom. In embodiments in which the devices 106, 110 are connected to form a virtual classroom, the devices can be connected via, for example, a WAN, a cellular network, a telephone communication network, or the like.

In embodiments in which the devices 106, 110 are connected in a classroom environment. In such a classroom environment, the user devices 106 and the supervisor device 110 can be connected to each other via, for example, a Local Area Network (LAN). This configuration can facilitate the quick transfer of data between the devices 106, 110 and can increase the speed with which survey data can be provided to the user devices 106 and survey data can be received form the user crevices 106 and provided to the supervisor device 110. In some such embodiments, the supervisor device 110 can be further connected with the back-end components 122 and can serve as a conduit for survey data from the user devices 106 to the back-end components 122. In such an embodiment, the supervisor device 110 can receive survey data from the user devices 106, can identify some or all of the survey data for local analysis, and can provide all of the survey data or the data not identified for local analysis to the back-end components 122. The supervisor device 110 can additionally, in some embodiments, locally analyze the portion of the survey data identified for local analysis and can use the analysis of this portion of the survey data to generate and provide one or more recommendations relating to content being delivered to the users of the user devices 106.

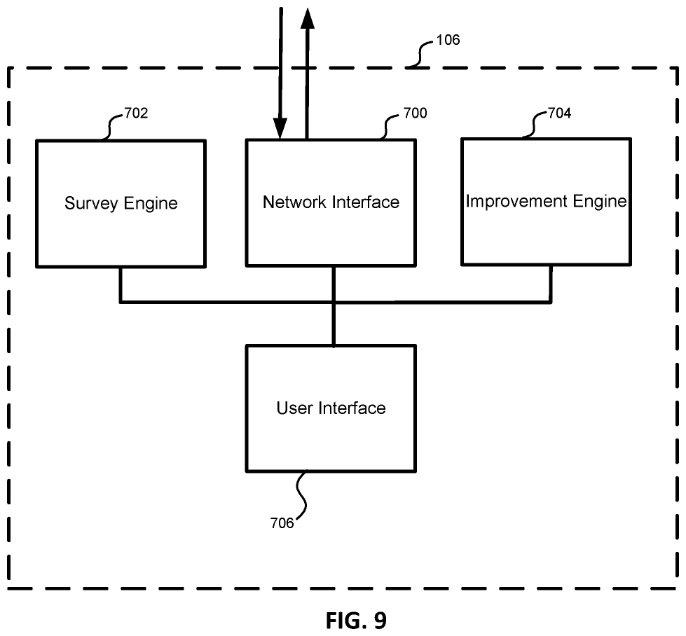

With reference now to FIG. 9, a block diagram of one embodiment of a user device 106 is shown. As discussed above, the user device 106 can be configured to provide information to and/or receive information from other components of the content distribution network 100. The user device can access the content distribution network 100 through any desired means or technology, including, for example, a webpage, a web portal, or via network 110.

As depicted in FIG. 9, the user device 106 can include a network interface 700. The network interface 700 allows the user device 106 to access the other components of the content distribution network 100, and specifically allows the user device 106 to access the communication network 120 of the content distribution network 100 either directly and/or via other devices such as, for example, the privacy server 108. The network interface 700 can include features configured to send and receive information, including, for example, an antenna, a modem, a transmitter, receiver, or any other feature that can send and receive information. The network interface 700 can communicate via telephone, cable, fiber-optic, or any other wired communication network. In some embodiments, the network interface 700 can communicate via cellular networks, WLAN networks, or any other wireless network.

The user device 106 can include a survey engine 702. The survey engine 702 can provide one or several surveys to the user, allow the generation and/or alteration of one or several surveys, allow the user to receive data relating to one or several completed surveys and/or one or several evaluations or evaluation reports, and/or store data relating to one or several surveys completed by the user.

The user device 106 can include an improvement engine 704. In some embodiments, the improvement engine 704 can be configured to receive information relating to one or several evaluations and/or evaluation reports from the evaluation engine 702 and retrieve information from the database server 104, and specifically from the survey database 311 of the database server 104, and to provide an improvement recommendation to the teacher/instructor. In some embodiments, the improvement engine 704 can further include features configured to facilitate in the completion and/or in achieving the benefit of the recommendation. In some embodiments, these features can include one or several follow-up features that can be used to determine if the teacher/instructor has acted on the recommendation

The user device 106 can include a user interface 706 that communicates information to, and receives inputs from a user. The user interface 706 can include a screen, a speaker, a monitor, a keyboard, a microphone, a mouse, a touchpad, a keypad, or any other feature or features that can receive inputs from a user and provide information to a user. In some embodiments, these features of the user interface can be configured to transform a physical input such as, for example, a pressure applied to a key, a mouse, a touchpad, a touchscreen, or the like and/or a pressure wave sensed at a microphone, into an electrical signal. Additionally, in some embodiments, portions of the user interface 706 can be configured to transform one or several electrical signals into physical outputs such as, for example, converting one or several electrical signals into the selective illumination and display of data via a screen and/or the generation of one or several sound waves via a speaker.

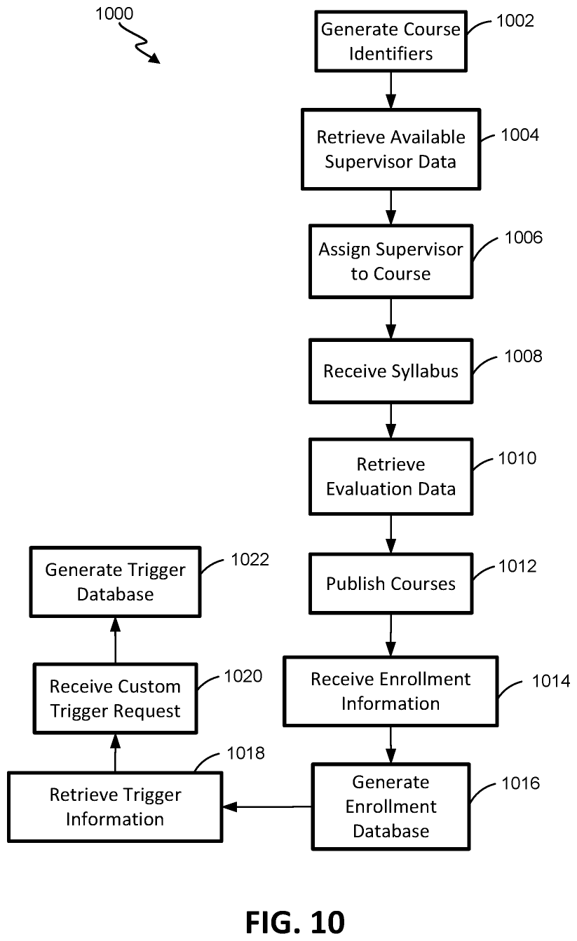

With reference now to FIG. 10, a flowchart illustrating one embodiment of a process 1000 for generating a trigger database is shown. The process 1000 begins in block 1002 wherein one or several course identifiers are generated and/or received. In some embodiments, these one or several course identifiers can comprise one or several pieces of data that identify one or several courses for future offering to one or several users such as student-users. In some embodiments, the course identifier can include information relating to, for example, the subject matter of the course, the time/location/frequency of the course, the pre-requisites for the course, or the like. In some embodiments, the course identifiers can be received from a device such as the supervisor device 110, and in some embodiments, the course identifiers can be received from the administrator server 116.

After the course identifiers have been received, the process 1000 proceeds to block 1004, wherein available supervisor data, such as teacher data, is retrieved. The available supervisor data can identify one or several supervisors and/or instructors that are available to direct courses. In some embodiments, this information can identify one or several supervisor qualifications to direct a course, one or several supervisor availabilities to direct the course, such as, for example, the supervisor's current teaching load, or the like. The supervisor data can be retrieved from one of the databases 104 including, for example, the user profile database 301.

After the available supervisor data has been retrieved, the process 1000 proceeds to block 1006, wherein one or several supervisors are assigned to a course. In some embodiments, this assignment can be made based on one or more of the supervisor availability and qualification to direct the course. After the supervisor assignment has been made, the process 1000 proceeds to block 1008, wherein the syllabus is received. In some embodiments, the syllabus can outline content to be taught in the course to which the supervisor is assigned. In some embodiments, this outline can be specific and identify one or several assignments, tests, projects, or the like. The syllabus can be received from, for example, the supervisor via the supervisor device 110, and/or via the administrator device 116.

After the syllabus has been received, the process 1000 proceeds to block 1010, wherein the evaluation data is retrieved. In some embodiments, this evaluation data can be data received evaluating the supervisor and/or the course in the past. This evaluation data can be based on survey responses received from one or several student-users, and can be retrieved from one of the databases, and particularly from the evaluation database.

After the evaluation data has been retrieved, the process 1000 proceeds to block 1012, wherein the course is published as, for example, open for enrollment. After the course has been published, the process 1000 proceeds to block 1014, wherein enrollment information is received. In some embodiments, the enrollment information can identify one or several users for enrollment in the course. This enrollment information can be received from, for example, one or several users via one or several user devices 106.

After the enrollment information has been received, the process 1000 proceeds to block 1016, wherein general trigger information is received. In some embodiments, the general trigger information can identify one or standard triggers. These triggers can, for example, relate to attendance, participation, comprehension, or the like. In some embodiments, this general trigger information can be retrieved from one of the databases 104, and particularly from the trigger database

After the general trigger information has been received, the process 1000 proceeds to block 1018, wherein custom trigger information and/or requests are received. In some embodiments, the custom trigger information can identify one or several triggering situations and/or thresholds unique to the course and/or teacher. In some embodiments, these can be selected by the supervisor and in some embodiments, these can be selected by a manager of the supervisor. This custom trigger information can be received from, for example, one or several of the supervisor devices 110.

After the custom trigger request and/or information has been received, the process 1000 proceeds to block 1020, wherein a course trigger database is generated. In some embodiments, the course trigger database can be a subset of the trigger database, and can contain some or all of the triggers relevant to a course, and/or pointers to the same. The course trigger database can be generated as a portion of the trigger database.

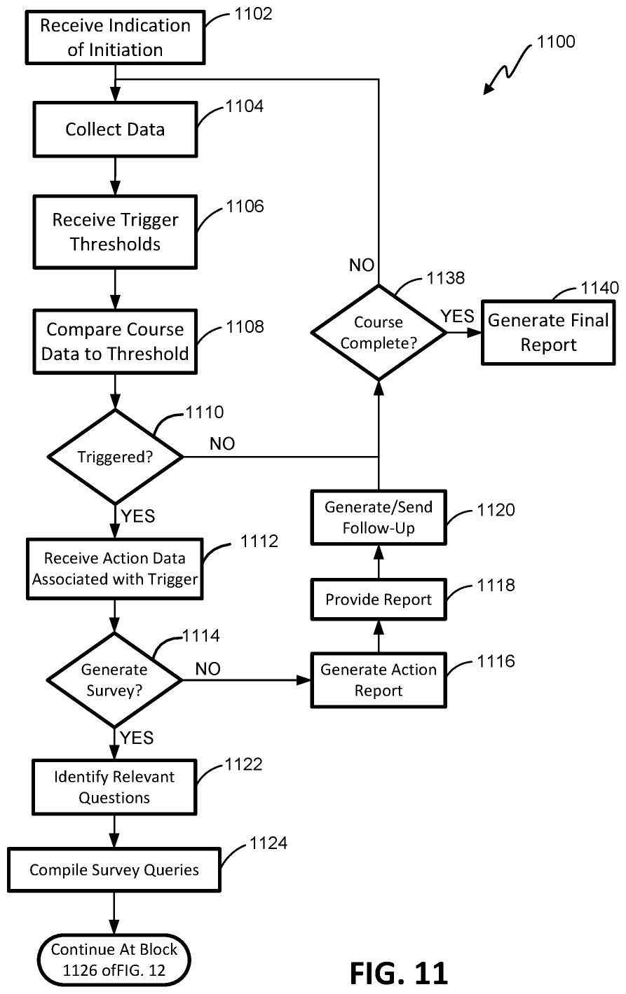

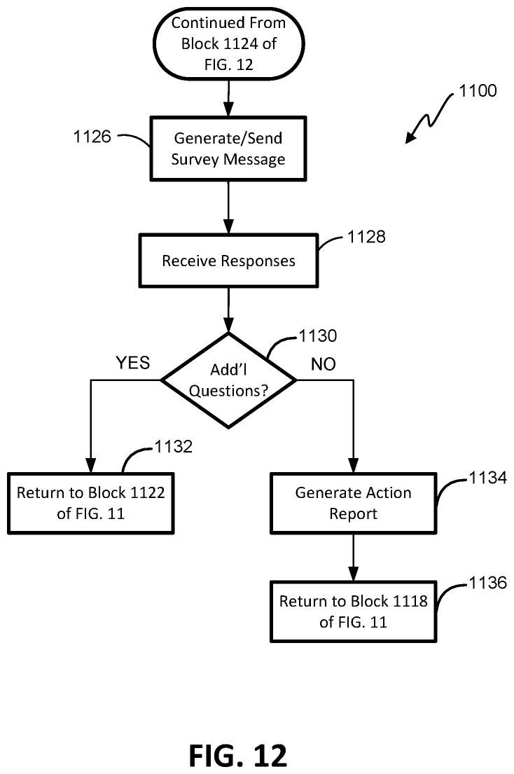

With reference now to FIGS. 11 and 12, a flowchart illustrating one embodiment of a process 1100 for triggering an evaluation is shown. The process 1100 begins at block 1102, wherein an indication of the initiation of a course is received. In some embodiments, this indication can comprise information indicating that the data of the start of a course has arrived, information indicating that the first lecture for a course has taken place, or the like. After the indication of the initiation of the course has been received, the process 1100 proceeds to block 1104, wherein course data is collected. In some embodiments, the course data can be collected by the content distribution network 100 and/or components thereof including, for example, the content management server 102. This course data can be collected from one or several of the supervisor device 110, and the user devices 106. The course data can identify one or several attributes of the course. These attributes can include, for example, one or more of: scores such as an assignment score or performance level, data transmission records identifying transmitted data packets, attendance, participation, or the like.

After the course data has been collected, the process 1100 proceeds to block 1106, wherein one or several triggers are retrieved. In some embodiments, the one or several triggers are retrieved from the database 104, and specifically can be retrieved from the course trigger database. After the triggers have been retrieved, the process 1100 proceeds to block 1108, wherein the course data is compared with one or several of the triggers, and specifically with the one or several thresholds associated with the triggers to determine if a trigger is tripped. In some embodiments, the comparison can be performed by the content management server 102 and/or another component of the content distribution network 100.

After the course data has been compared to the triggers, the process 1100 proceeds to decision state 1110 wherein it is determined if one of the triggers has been tripped and/or triggered. In some embodiments, this can include an evaluation of the results of the comparison of the course data to the triggers, which evaluation can be performed by the content management server 102. If it is determined that the trigger has not been tripped, the process 1100 returns to block 1104, and proceeds as outlined above.

Returning again to decision state 1110, if it is determined that the trigger has been tripped, the process 1100 proceeds to block 1112, wherein action data associated with the trigger is received. In some embodiments, the action data can prescribe one or several actions to take in response to the trigger. These actions can include, for example, notifying the instruction, notifying a supervisor of the instructor, notifying one or several of the students, one or several parents, or the like. In some embodiments, these actions can include one or several remedial actions for one or both of the teacher and the students, the gathering of evaluation data via one or several surveys, or the like. In some embodiments, the action data can be stored in one of the databases 104.

After the action data has been received, the process 1100 proceeds to decision state 1114, wherein it is determined whether to generate a survey. In some embodiments, this determination can be made according to the tripped trigger and/or the received action data, and this determination can be made by, for example, the content management server 102. If it is determined that a survey should not be generated, the process 1100 proceeds to block 1116, wherein an action report is generated. In some embodiments, the action report can be generated by the content management server 102, and the action report can provide information regarding the tripped trigger. In some embodiments, the action report can further include information identifying one or several courses of action to improve the course, the teacher and/or to assist one or several students.

In some embodiments, the action report can comprise an alert that can be sent, by the content distribution network 100 to one or more user devices 106 and/or one or more supervisor devices 110 via, for example, the communication network 120. In some embodiments, the receipt of the alert can result in the launching of an application within the receiving device, and in some embodiments, the alert can include a link that, when selected, launches the application or navigates a web-browser of the device of the selector of the link to page or portal associated with the alert.

In some embodiments, for example, the providing of this alert can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this alert can include determining an active device of the devices 106, 110 based on determining which of the devices 106, 110 and/or accounts are actively being used, and then providing the alert to that active device.

Specifically, if the user is actively using one of the devices 106, 110 such as the other user device 106-B and the other supervisor device 110-B, and/or accounts, the alert can be provided to the user via that other device 106-B, 110-B and/or account that is actively being used. If the user is not actively using another device 106-B, 110-B and/or account, a personal device 106-A, 110-A device, such as a smart phone or tablet, can be identified and the alert can be provided to this personal device 106-A, 110-A. In some embodiments, the alert can include code to direct the recipient device to provide an indicator of the received alert such as, for example, an aural, tactile, or visual indicator of receipt of the alert.

In some embodiments, the recipient device 106, 110 of the alert can provide an indication of receipt of the alert. In some embodiments, the presentation of the alert can include the control of the I/O subsystem 526 to, for example, provide an aural, tactile, and/or visual indicator of the alert and/or of the receipt of the alert. In some embodiments, this can include controlling a screen of the supervisor device 110 to display the alert, data contained in alert and/or an indicator of the alert.

After the action report is generated, the process 1100 proceeds to block 1118, wherein the report is provided to one or several recipients, and the process 1100 then proceeds to block 1120 wherein a follow-up is made on the report. In some embodiments, the follow-up on the report can be made to determine if the action report was used. \

In some embodiments, after the follow-up has been generated and sent, the process 1100 proceeds to decision state 1138, wherein it is determined if the course is complete. In some embodiments, this can include determining, according to an electronic syllabus, schedule, or the like, if the course has been completed. If the course has been completed, the process 1100 proceeds to block 1140, wherein a final report is generated and/or sent. In some embodiments, the final report can comprise the aggregation of the data contained in some or all of the action reports generated associated with a course. In some embodiments, this can include information identifying the effectiveness of the course, feedback regarding the course, or the like. In some embodiments, this final report can be provided to the user device 106 or supervisor device 110 via, for example, an alert as discussed above. Returning again to decision state 1138, if it is determined that the course is not complete, then the process 1100 continues to block 1104, and proceeds as outlined above.

Returning again to decision state 1114, if it is determined that a survey should be generated, the process 1100 proceeds to block 1122, wherein one or several relevant questions are identified. In some embodiments, these one or several relevant questions can be identified within the question database of the survey database 311, and the one or several appropriate questions, based on the trigger, the subject area of the question, and the specificity level of the question can be selected. After the relevant questions have been identified, the process 1100 proceeds to block 1124, wherein the identified survey questions are compiled into a survey. In some embodiments, this compilation can be performed by the content management server 102, and the resulting compiled survey can be stored in one of the databases 104.

After the survey questions have been compiled, the process 1100 proceeds to block 1126, wherein the survey is provided. In some embodiments, the providing of the survey can include the generation and/or sending of a survey message. In some embodiments, the survey can be provided to one or several users in the course, via, for example, one or several user devices 106. In some embodiments, the content distribution network can send one or more survey messages to one or more user devices 106 and/or one or more supervisor devices 110 via, for example, the communication network 120. In some embodiments, the receipt of the survey message can result in the launching of an application that can contain a survey within the receiving device, and in some embodiments, the survey message can include a link that, when selected, launches the application or navigates a web-browser of the device of the selector of the link to page or portal associated with the survey message.

In some embodiments, for example, the providing of this survey message can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this survey message can include determining an active device of the devices 106, 110 based on determining which of the devices 106, 110 and/or accounts are actively being used, and then providing the survey message to that active device.

Specifically, if the user is actively using one of the devices 106, 110 such as the other user device 106-B and the other supervisor device 110-B, and/or accounts, the survey message can be provided to the user via that other device 106-B, 110-B and/or account that is actively being used. If the user is not actively using another device 106-B, 110-B and/or account, a personal device 106-A, 110-A device, such as a smart phone or tablet, can be identified and the survey message can be provided to this personal device 106-A, 110-A. In some embodiments, the survey message can include code to direct the recipient device to provide an indicator of the received survey message such as, for example, an aural, tactile, or visual indicator of receipt of the survey message.

After the surveys have been provided, the process 1100 proceeds to block 1128, wherein survey responses, in the form of electronic communications, are received. In some embodiments, these survey responses can be received from the user devices 106 by the content management server 102.

After the survey responses have been received, the process 1100 proceeds to decision state 1130, wherein it is determined if additional questions should be used to generate additional surveys. In some embodiments, for example, the answers received can be compared to one or several metrics to identify one or several issue and/or areas of unclarity in the survey data. These can be identified by, for example, an indicated discrepancy between the level of understanding of some of the users in the course and user grades, a discrepancy between attendance and/or participation and grades, a number of poor survey results, or the like. If it is determined that additional survey data is desired, additional questions can be selected, and additional questions can be compiled into additional surveys. In such an embodiment, if it is determined that additional survey data is desired, then the process 1100 returns to block 1122 and proceeds as outlined above.

If it is determined that additional survey data is not desired, then the process 1100 proceeds to block 1132, wherein an action report is generated. In some embodiments, the action report can be generated by the content management server 102, and the action report can provide information regarding the tripped trigger. In some embodiments, the action report can further include information identifying one or several courses of action to improve the course, the teacher and/or to assist one or several users. After the action report has been generated, the process returns to block 1118, and proceeds as outlined above.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

The invention claimed is:

1. A system comprising:
a data store including a course data associated with a learning course, the course data comprising an event in the learning course;
a first client device coupled to an electronic network and configured to display a first Graphical User Interface (GUI), the first GUI configured to receive a first user input including:
a survey question identifying an issue specific to an instructor, a student, or at least one learning material associated with the learning course; and
a trigger associated with the survey question and the event, the trigger defining an action item automatically executed in response to an occurrence of the event;
a server comprising a hardware computing device coupled to a network and comprising at least one processor executing instructions within a memory that, when executed, cause the system to:
receive the survey question and the trigger;
store the survey question and the trigger in the data store;
responsive to a determination that the event has occurred:
identify a target user within the course data;
automatically generate a survey comprising the survey question; and
transmit the survey to a second client device operated by the target user; and
the second client device configured to:
receive the survey;
display the survey on a second GUI; and
receive a second user input comprising a response to the survey question.

2. The system of claim 1, wherein the instructions further cause the server to:
receive, from the second user device, the response to the survey question;
generate a report comprising at least one recommendation for a remedial action associated in the data store with the survey question; and
transmit the report to the first client device.

3. The system of claim 1, wherein the instructions further cause the server to:
receive the first user input comprising:
the course data, including at least one outline, model, plan, syllabus, subject matter, time, location, or prerequisite for the learning course;
the at least one learning material for the learning course;
at least one course-based survey question specific to the learning course; and
at least one trigger, associated with at least one course-based survey question; and
store, in association in the data store, the course data, the at least one learning material,
the at least one course-based survey question, and the at least one trigger.

4. The system of claim 1, wherein the instructions further cause the server to:
receive, the first user input comprising:
at least one instructor or learning material-based survey question specific to the instructor or the at least one learning material; and
at least one trigger, associated with at least one of the at least one instructor or learning material-based survey question; and
store, in association in the data store, the at least one instructor or learning material-based survey question, and the at least one trigger.

5. A method comprising:
storing, within a data store coupled to an electronic network, a course data associated with a learning course, the course data comprising an event in the learning course
receiving, by a server comprising a hardware computing device coupled to the electronic network and comprising at least one processor executing instructions within a memory, from a first client device configured to display a first Graphical User Interface (GUI), a first user input including:
a survey question identifying an issue specific to an instructor, a student, or at least one learning material associated with the learning course;
a trigger associated with the survey question and the event, the trigger defining an action item automatically executed in response to an occurrence of the event;
receiving, by the server, the survey question and the trigger;
storing, by the server, the survey question and the trigger in the data store;
responsive to a determination that the event has occurred:
identifying a target user within the course data;
automatically generating a survey comprising the survey question; and
transmitting the survey to a second client device operated by the target user for display on a second GUI on the second client device; and
receiving, from the second client device, a response to the survey question.

6. The method of claim 5, further comprising the steps of:
receiving, by the server from the first client device, the trigger, wherein the event comprises a passage of an interval of time;
determining, by the server, that the interval of time has passed;
automatically generating, by the server, the survey in response to a passing of the interval of time; and
transmitting, by the server, the survey to the second user device.

7. The method of claim 5, further comprising the steps of:
receiving, by the server, from the first client device:
a threshold defining a low performance in the learning course;
the trigger, wherein the event comprises a performance data associated with at least one student of the learning course, wherein the performance data is below the threshold;
determining, by the server, that the performance data is below the threshold;
automatically generating, by the server, the survey in response to the performance data being below the threshold; and
transmitting, by the server, the survey to the second user device.

8. The method of claim 5, further comprising the steps of:
receiving, by the server, from the first client device:
at least one learning objective associated with the learning course;
a threshold defining a minimum performance for the at least one learning objective;
the trigger, wherein the event comprises a performance data associated with at least one student of the learning course, wherein the performance data is below the threshold;
determining, by the server, that the performance data is below the threshold;
automatically generating, by the server, the survey in response to the performance data being below the threshold; and
transmitting, by the server, the survey to the second user device.

9. The method of claim 5, further comprising the steps of:
receiving, by the server from the first client device, the trigger, wherein the occurrence of the event comprises that the course data indicates that the learning course has begun;
determining, by the server, from the course data, that the learning course has begun;
automatically generating, by the server, the survey in response to a beginning of the learning course; and
transmitting, by the server, the survey to the second user device.

10. The method of claim 5, further comprising the steps of:
receiving, within the first user input from the first client device, an indication that the survey should be immediately transmitted to the second client device; and
automatically transmitting the survey to the second client device immediately following a generation of the survey.

11. A system comprising a server, comprising a hardware computing device coupled to a network and comprising at least one processor executing instructions within a memory, the server being configured to:
store, within a data store coupled to the electronic network, a course data associated with a learning course, the course data comprising an event in the learning course
receive, from a first client device configured to display a first Graphical User Interface (GUI), a first user input including:
a survey question identifying an issue specific to an instructor, a student, or at least one learning material associated with the learning course;
a trigger associated with the survey question and the event, the trigger defining an action item automatically executed in response to an occurrence of the event;
receive the survey question and the trigger;
store the survey question and the trigger in the data store;
responsive to a determination that the event has occurred:
identify a target user within the course data;
automatically generate a survey comprising the survey question; and
transmit the survey, to a second client device operated by the target user, for display on a second GUI on the second client device; and
receive, from the second client device, a response to the survey question.

12. The system of claim 11, wherein the server is further configured to:
aggregate the results within the data store at the end of the survey; and
aggregate the results of all surveys at the end of the course; and
generate and transmit a(n action) report at the end of the course from the aggregated data.

13. The system of claim 11, wherein the server is further configured to:
generate a notification, to accompany the survey, wherein the notification is audio, visual, or tactile;
transmit the survey and the notification to the second client device for execution and display on the second client device

14. The method of claim 11, wherein the server is further configured to:
store, within the course data in the data store:
an instructor data comprising an availability and at least one qualification for an instructor of the course; and
a plurality of previously-received survey responses associated in the data store with the learning course; and
automatically assign the instructor to the learning course, based on the availability, the at least one qualification, and the plurality of previously-received survey responses.
automatically generate, for display on the second client device, a third GUI configured to receive enrollment data for the course from at least one student.

15. The system of claim 11, wherein the server is further configured to:
identify, within the data store, at least one additional survey question
responsive to a determination that the at least one additional survey question is associated in the data store with the event, including the at least one additional survey question in the survey.

16. The system of claim 15, wherein the server is further configured to:
receive, from the first client device, the trigger, wherein the event comprises a passage of an interval of time;
determine that the interval of time has passed;
automatically generate the survey in response to a passing of the interval of time; and
transmit the survey to the second user device.

17. The system of claim 15, wherein the server is further configured to:
receive, from the first client device:
a threshold defining a low performance in the learning course;
the trigger, wherein the event comprises a performance data associated with at least one student of the learning course, wherein the performance data is below the threshold;
determine that the performance data is below the threshold;
automatically generate the survey in response to the performance data being below the threshold; and
transmit the survey to the second user device.

18. The system of claim 15, wherein the server is further configured to:
Receive, from the first client device:
at least one learning objective associated with the learning course;
a threshold defining a minimum performance for the at least one learning objective;
the trigger, wherein the event comprises a performance data associated with at least one student of the learning course, wherein the performance data is below the threshold;
determine that the performance data is below the threshold;
automatically generate the survey in response to the performance data being below the threshold; and
transmit the survey to the second user device.

19. The system of claim 15, wherein the server is further configured to:
receive, from the first client device, the trigger, wherein the occurrence of the event comprises that the course data indicates that the learning course has begun;
determine, from the course data, that the learning course has begun;
automatically generate the survey in response to a beginning of the learning course; and
transmit the survey to the second user device.
